(19) United States
(12) Patent Application Publication
(10) Pub. No.: US 2014/0227668 A1
(43) Pub. Date: Aug. 14, 2014

(54) System to Help Teachers Lead Classroom Conversations in Mathematics

(71) Applicant: CONCEPTUA MATH, Petaluma, CA (US)

(72) Inventors: Arjan KHALSA, San Rafael, CA (US); Fred ROSS-PERRY, Petaluma, CA (US); Lauri SUSI, Petaluma, CA (US)

(21) Appl. No.: 14/257,961

(22) Filed: Apr. 21, 2014

Related U.S. Application Data
(63) Continuation-in-part of application No. 12/960,337, filed on Dec. 3, 2010.
Application No. 12/960,337 is a continuation-in-part of application No. 13/860,389, filed on Apr. 10, 2013.
(60) Provisional application No. 61/622,943, filed on Apr. 11, 2012.
(60) Provisional application No. 61/813,962, filed on Apr. 19, 2013.

(51) Int. Cl. G09B 7/08

(52) U.S. Cl. CPC G09B 7/08
USPC 434/188

(57) ABSTRACT

Introduced herein is a technique that includes digital opening math discussions (“openers”) and digital dosing math discussions (“closers”) through the use of manipulative models in combination with well-authored and strategically placed sticky notes that can contain teacher instructions (“teacher ‘i’s”) and through the user of strategic feedback. This technique allows teachers to gain confidence while delivering research-based instruction.

### CROSS REFERENCE TO RELATED APPLICATIONS

This patent application is a continuation-in-part of U.S. patent application Ser. No. 12/960,337, APPARATUS AND METHOD FOR TOOLS FOR MATHEMATICS INSTRUCTION, filed Dec. 3, 2010 and this application is a continuation-in-part of U.S. patent application Ser. No. 13/860,389, APPARATUS AND METHOD FOR TOOLS FOR MATHEMATICS INSTRUCTION, filed Apr. 10, 2013, which claims benefit of Provisional Application No. 61/622,943, MULTIPLYING FRACTIONS, filed Apr. 11, 2012, and this application claims benefit of Provisional Application No. 61/813,962, SYSTEM TO HELP TEACHER LEAD CLASSROOM CONVERSATION IN MATHEMATICS, filed Apr. 19, 2013, the entirety of all of which are incorporated herein by this reference thereto.

### BACKGROUND OF THE INVENTION

1. Technical Field

This invention relates generally to the field of computer-implemented educational tools for teachers in classroom mathematics instruction. More specifically, this invention relates to a technique to help teachers lead classroom discussions in mathematics.

2. Description of the Related Art

Educators understand that discussion in mathematics (“math”) are a best practice that lead to student learning. However, some teachers lack confidence in delivering mathematical instruction, especially with more difficult topics, such as fractions. As well, in addition to pedagogical reasoning, teachers understand that high quality math discussion is time consuming to plan, even in view of the research-based resources provided to them.

### SUMMARY OF THE INVENTION

Introduced herein is a technique that includes digital opening math discussions (“openers”) and digital closing math discussions (“closers”) through the use of manipulative models in combination with well-authored and strategically placed sticky notes that can contain teacher instructions (“teacher ‘i’s”) and through the user of strategic feedback. This technique allows teachers to gain confidence while delivering research-based instruction.

### BRIEF DESCRIPTION OF THE DRAWINGS

FIG. 1 is a schematic diagram showing a sample screen shot of an opener screen, according to an embodiment;

FIG. 2 is a schematic diagram showing a sample screen shot of a pre-populated problem screen, according to an embodiment;

FIG. 3 is a schematic diagram showing a sample screen shot of navigation buttons, according to an embodiment;

FIG. 4 is a sample screen shot of a screen that has been completed by a student, according to an embodiment;

FIG. 5 is a sample screen shot of the same screen of FIG. 4 after being reset, according to an embodiment;

FIG. 6A is a sample screen shot of checked work feedback for a correct answer, according to an embodiment;

FIG. 6B is a sample screen shot of checked work feedback for an incorrect answer, according to an embodiment;

FIG. 7A is a sample screen shot of a screen before clicking the previous screen button, according to an embodiment;

FIG. 7B is a sample screen shot of a screen after clicking the previous screen button, according to an embodiment;

FIG. 8A is a sample screen shot of a screen before clicking the next screen button, according to an embodiment;

FIG. 8B is a sample screen shot of a screen after clicking the next screen button, according to an embodiment;

FIG. 9A is a sample screen shot of a screen before clicking the dose button, according to an embodiment;

FIG. 9B is a sample screen shot of a screen after clicking the dose button, according to an embodiment;

FIG. 10A is a schematic diagram showing a sample screen shot of an example of feedback for an incorrect answer, according to an embodiment;

FIG. 10B is a schematic diagram showing a sample screen shot of another example of feedback for an incorrect answer, according to an embodiment;

FIG. 10C is a schematic diagram showing a sample screen shot of another example of feedback for an incorrect answer, according to an embodiment;

FIG. 10D is a schematic diagram showing a sample screen shot of another example of feedback for an incorrect answer, according to an embodiment;

FIG. 10E is a schematic diagram showing a sample screen shot of another example of feedback for an incorrect answer, according to an embodiment;

FIG. 11A is a schematic diagram showing a sample screen shot of a talk about opener, according to an embodiment;

FIG. 11B is a schematic diagram showing a sample screen shot of a talk about opener, according to an embodiment;

FIG. 11C is a schematic diagram showing a sample screen shot of a talk about opener, according to an embodiment;

FIG. 12A is a schematic diagram showing a sample screen shot of a think-pair-share opener, according to an embodiment;

FIG. 12B is a schematic diagram showing a sample screen shot of a think-pair-share opener, according to an embodiment;

FIG. 12C is a schematic diagram showing a sample screen shot of a think-pair-share opener, according to an embodiment;

FIG. 12D is a schematic diagram showing a sample screen shot of a think-pair-share opener, according to an embodiment;

FIG. 13A is a schematic diagram showing a sample screen shot of a hands-on opener, according to an embodiment;

FIG. 13B is a schematic diagram showing a sample screen shot of a hands-on opener, according to an embodiment;

FIG. 13C is a schematic diagram showing a sample screen shot of a hands-on opener, according to an embodiment;

FIG. 14A is a schematic diagram showing a sample screen shot of a walk-about opener, according to an embodiment;

FIG. 14B is a schematic diagram showing a sample screen shot of a walk-about opener, according to an embodiment;

FIG. 15A is a schematic diagram showing a sample screen shot of an explain and solve closer, according to an embodiment;

FIG. 15B is a schematic diagram showing a sample screen shot of an explain and solve closer, according to an embodiment;

FIG. 15C is a schematic diagram showing a sample screen shot of an explain and solve closer, according to an embodiment;

FIG. 16 is a schematic diagram showing a sample screen shot of closer summary statement, according to an embodiment;

FIG. 17A is a schematic diagram showing a sample screen shot of an agree/disagree closer, according to an embodiment;

FIG. 17B is a schematic diagram showing a sample screen shot of an agree/disagree closer, according to an embodiment;

FIG. 17C is a schematic diagram showing a sample screen shot of an agree/disagree closer, according to an embodiment;

FIG. 18 is a schematic diagram showing a sample screen shot of closer summary statement, according to an embodiment;

FIG. 19A is a schematic diagram showing a sample screen shot of an apply your knowledge closer, according to an embodiment;

FIG. 19B is a schematic diagram showing a sample screen shot of an apply your knowledge closer, according to an embodiment;

FIG. 20 is a schematic diagram showing a sample screen shot of a guided lesson, according to an embodiment;

FIG. 21 is a schematic diagram showing a sample screen shot of closer summary statement, according to an embodiment;

FIG. 22A is a schematic diagram showing a sample screen shot of a pre-populated visual model, according to an embodiment;

FIG. 22B is a schematic diagram showing a sample screen shot of pre-populated number fields, according to an embodiment;

FIG. 22C is a schematic diagram showing a sample screen shot of a pre-populated number line, according to an embodiment;

FIG. 22D is a schematic diagram showing a sample screen shot of a pre-populated problem context and visual model, according to an embodiment;

FIG. 22E is a schematic diagram showing a sample screen shot of pre-populated context and paraphrase, according to an embodiment;

FIG. 22F is a schematic diagram showing a sample screen shot of a pre-populated screen with some visual models and some number fields, according to an embodiment;

FIG. 22G is a schematic diagram showing a sample screen shot of pre-populated visual models and number fields, according to an embodiment;

FIG. 23A is a schematic diagram showing a sample screen shot of an example of a problem from the end of lesson 2 of a guided lesson, according to an embodiment;

FIG. 23B is a schematic diagram showing a sample screen shot of an example of the first problem from the opener for lesson 3 of the guided lesson, according to an embodiment;

FIG. 23C is a schematic diagram showing a sample screen shot of an example of the third problem from the opener for the lesson 3 guided lesson, according to an embodiment;

FIG. 23D is a schematic diagram showing a sample screen shot of an example of the first problem from the lesson 3 guided lesson, according to an embodiment;

FIG. 23E is a schematic diagram showing a sample screen shot of an example of the last problem from the lesson 3 guided lesson, according to an embodiment;

FIG. 23F is a schematic diagram showing a sample screen shot of an example screen from the lesson 3 closer, according to an embodiment;

FIG. 24A is a schematic diagram showing a sample screen shot of a pre-populated screen that is locked, according to an embodiment;

FIG. 24B is a schematic diagram showing a sample screen shot of a pre-populated screen that is unlocked, according to an embodiment;

FIG. 24C is a schematic diagram showing a sample screen shot of a pre-populated screen that has elements unlocked, according to an embodiment;

FIG. 24D is a schematic diagram showing a sample screen shot of a pre-populated screen that requires the user to further populate fields and then lock the fields before continuing with the problem, according to an embodiment;

FIG. 25A is a schematic diagram showing a sample screen shot of a screen prior to user interaction, according to an embodiment;

FIG. 25B is a schematic diagram showing a sample screen shot of a screen after user interaction, according to an embodiment;

FIG. 25C is a schematic diagram showing a sample screen shot of an example screen after resetting, according to an embodiment;

FIG. 26A is a schematic diagram showing a sample screen shot of a sticky note being located in the bottom right position, according to an embodiment;

FIG. 26B is a schematic diagram showing a sample screen shot of a sticky note being moved around the screen to any location, according to an embodiment;

FIG. 26C is a schematic diagram showing a sample screen shot of gray circles at the top of the sticky note to inform the user how many sticky notes are in the sequence, according to an embodiment;

FIG. 26D is a schematic diagram showing a sample screen shot of blue arrows allowing the user to navigate through the sticky notes, according to an embodiment;

FIG. 26E is a schematic diagram showing a sample screen shot of when the user has reached the last sticky note and the final gray circle being dark and the right arrow being faded, according to an embodiment;

FIG. 26F is a schematic diagram showing a sample screen shot of a sticky note being minimized and how it can be maximized, according to an embodiment;

FIG. 26G is a schematic diagram showing a sample screen shot of a sticky note being closed by clicking on the close button and being restored by clicking on the help button, according to an embodiment;

FIG. 27A-27AA are schematic diagrams showing sample screen shots of sticky notes, each of which is an example from an opener sequence or a closer sequence, according to an embodiment;

FIG. 28A-28I are schematic diagrams showing sample screen shots of a teacher i on a sticky note, according to an embodiment; and

FIG. 29 is a block schematic diagram of a system in the exemplary form of a computer system according to an embodiment.

### DETAILED DESCRIPTION OF THE INVENTION

Introduced herein is a technique that includes digital opening math discussions (“openers”) and digital closing math discussions (“closers”) through the use of models, sticky notes, teacher instructions (“teacher ‘i’s”), and strategic feedback. This technique allows teachers to gain confidence while delivering research-based instruction.

Even teachers who are confident leading mathematic discussions recognize the benefits of integrating digital technology. Working with interactive models, students can create accurate models and are not subject to inaccuracies that may lead to misconceptions. Computer models are also easier to create and modify, allowing for the ability to test hypotheses and to flexibly respond to student discussion. Teachers also recognize that their students are engaged by the ability to interact with the technology rather than just passively listen.

### Introduction

Openers and closers frame the guided lessons, e.g. Conceptua Math Guided Lessons, with teacher-driven, whole-class instruction. Openers provide the classroom teacher with powerful and engaging learning experiences to deliver to their students prior to the students interacting with the guided lessons. Closers provide opportunities to further develop, solidify, and assess student understanding following the guided lessons. These openers and closers can be configured using visual learning tools used in commonly assigned and currently pending patent applications: U.S. patent application Ser. No. 12/960,337, APPARATUS AND METHOD FOR TOOLS FOR MATHEMATICS INSTRUCTION, filed Dec. 3, 2010 and U.S. patent application Ser. No. 13/860,389, APPARATUS AND METHOD FOR TOOLS FOR MATHEMATICS INSTRUCTION, filed Apr. 10, 2013.

The openers and closers enable the following best practice-based learning scenarios to occur:
The students are informed of the key concept of the lesson on the title screen.
The teacher facilitates a classroom discussion, based on the Standards of Mathematical Practice, using pre-populated problem screens.
   During the opener the sticky notes guide this discussion by reviewing and linking previous learning to content in the guided lesson, introducing new content and addressing possible misconceptions.
   During the closer the sticky notes guide students to summarize the content in the guided lesson, link new learning to previous learning and/or the real world, and provide opportunities for the teacher to check for comprehension.
   The teacher acquires on-demand professional development, content knowledge, and information on software manipulation by clicking on the teacher i. A teacher i is configured to contain specific content to guide the teacher to notice what is occurring in the class regarding the discussion as well as when something specific is occurring in the discussion, how the teacher can address the issue.

### Openers and Closers

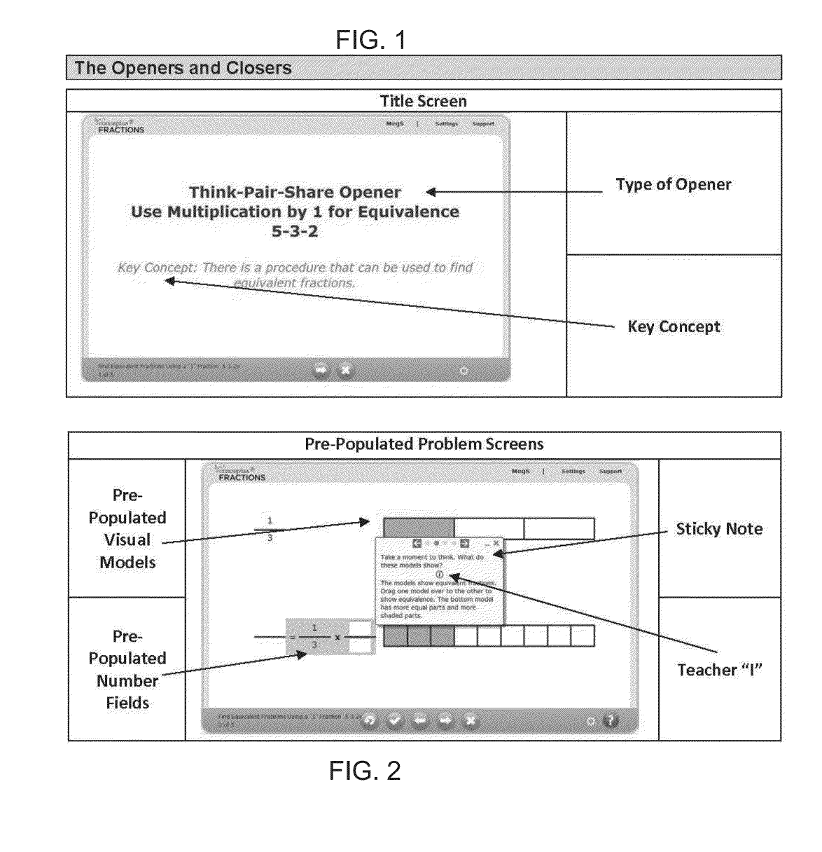

An embodiment of an opener and a closer can be understood with reference to FIG. 1 and FIG. 2.

Elements.

In an embodiment, an opener and a closer contain four essential elements:
Title Screen
   Type of Opener
   Key Concept
Pre-Populated Content
   Pre-Populated Models
   Pre-Populated Number Fields
Sticky Notes
Teacher “I”

The combination of the pre-populated screens, sticky notes and teacher i's is unique in the delivery of best practice instruction in addition to providing on-demand professional development.

Navigation Buttons.

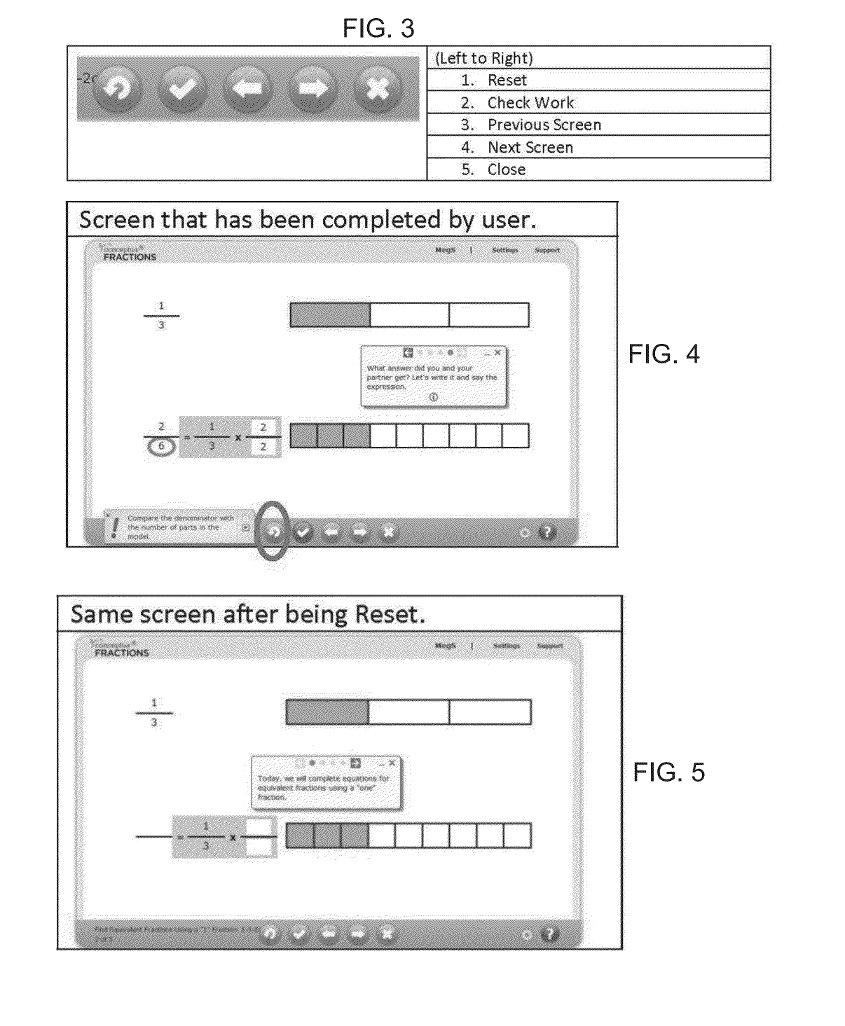

The embodiment comprises navigation buttons which are significant features to the opener and closer because the buttons allow the teacher to control the displayed screens based on the needs of the learners in their classroom. For example, if a student asks a question in reference to the pre-populated problem on screen 2 while the class is discussing the pre-populated problem on screen 4, the teacher can click the “previous screen” button twice to return to screen 2. The navigation buttons can be understood with reference to FIG. 3.

The navigation buttons are configured to perform five different types of functions, described below.

Reset. By clicking on the reset or dear screen button, the user can dear changes they made to the pre-populated screen and the screen will be restored to the original, pre-populated state (FIG. 4 and FIG. 5).

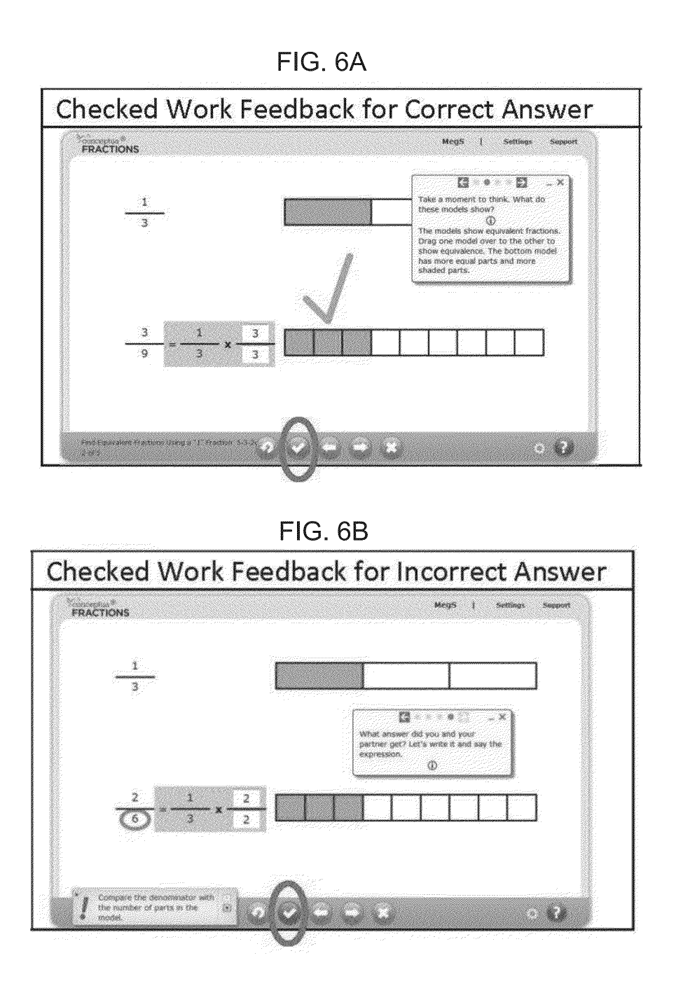

Check Work. After inputting numbers into open fields and/or manipulating models, the user can click on the check work button. Feedback is given in the form of a green check mark, for a correct answer, or a red dialogue box with specific feedback hints and red circles over areas of the screen that contain errors (FIG. 6A and FIG. 6B).

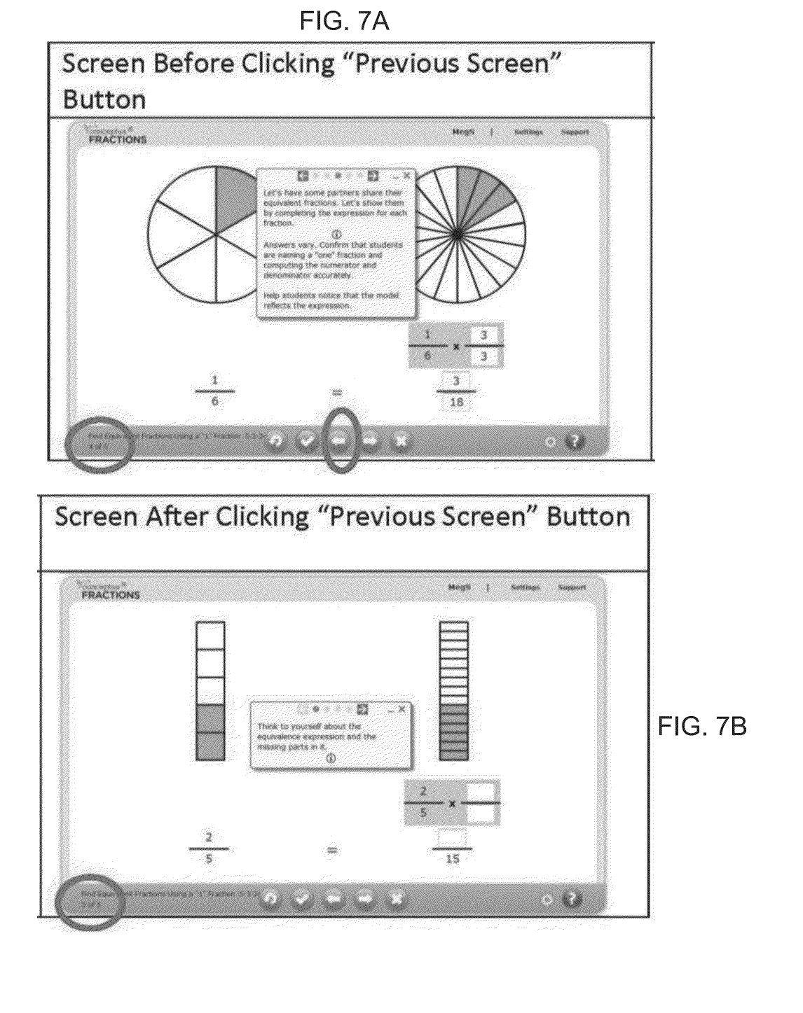

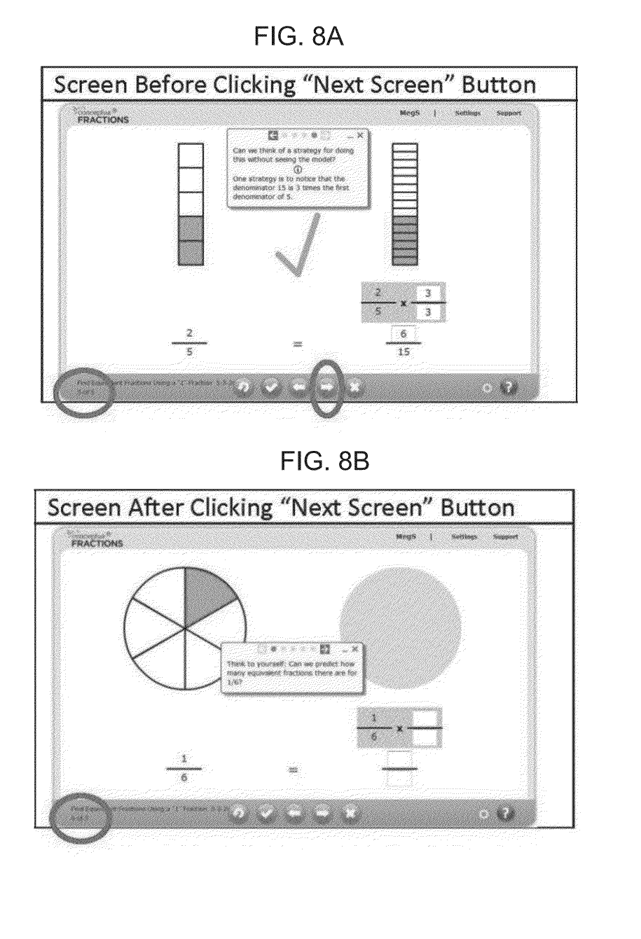

Previous Screen. The user can go back to the previous screen. When the user goes back to the previous screen, they will see the pre-populated problem screen free from any user data that had been previously input (FIGS. 7A, 7B, 8A, and 8B).

Next Screen. The user can go to the next screen prior to or after checking work.

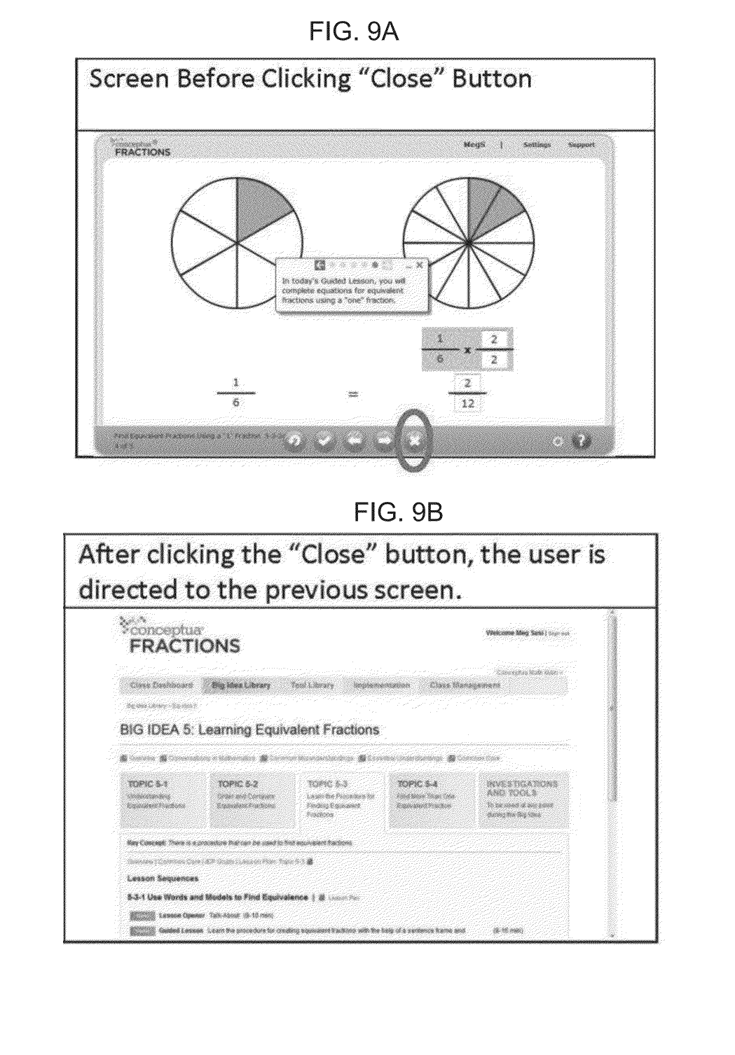

Close. The dose button doses the opener or closer and returns the user to the previous screen (FIG. 9A and FIG. 9B).

Feedback.

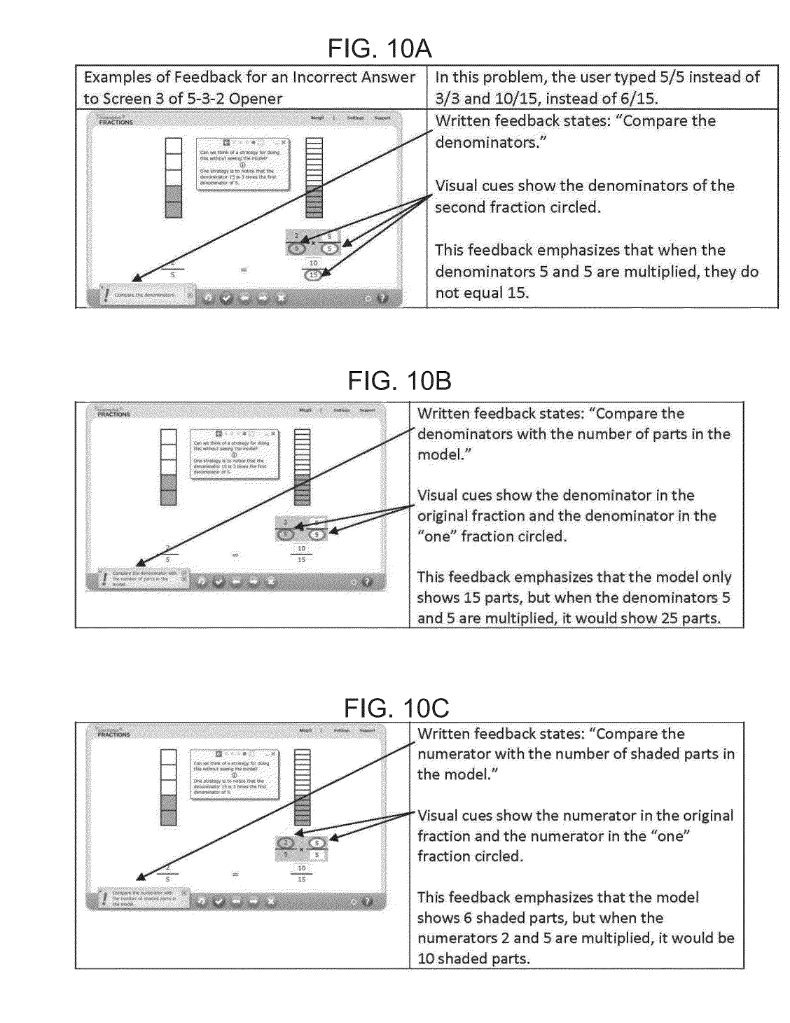

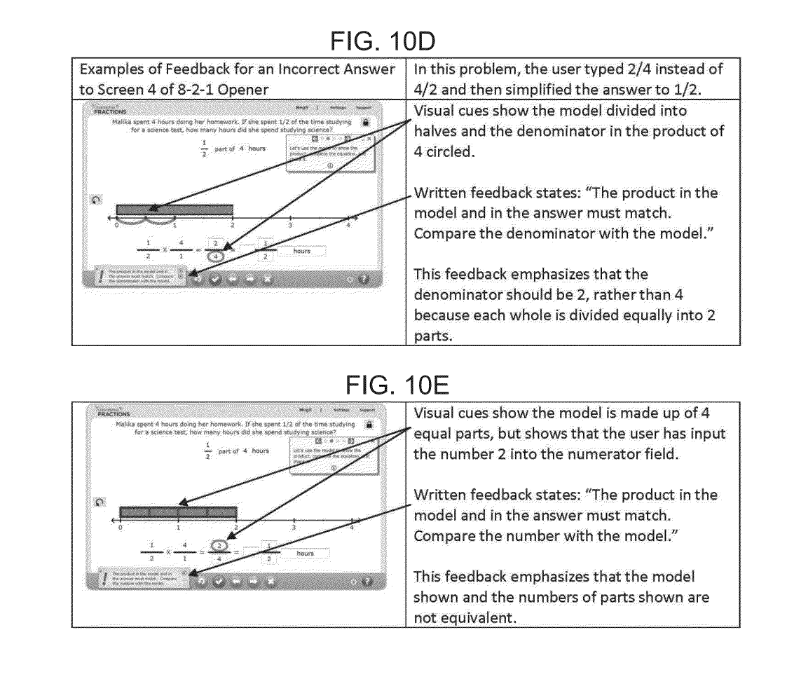

When the user clicks on the check work button, if all or part of the answer is incorrect, written and visual cue feedback are displayed. The feedback does not directly provide a correct answer, but rather indicates which elements or fields of the model and numbers should be addressed and why these elements have been called out. There may be multiple sets of feedback for a single answer, each error is addressed with a separate set of feedback. Feedback helps both students and teachers, if a teacher is unclear of how to move forward. Examples of feedback for an incorrect answer to a particular screen of a particular opener are provided in FIG. 10A, FIG. 10B, and FIG. 10C. The sticky notes contain a sequence of three sticky notes. The first sticky note displayed in the default stick note, as shown in FIG. 10A. The bottom arrow is active, indicating that there is at least another sticky note to follow in the sequence. FIG. 10B shows the next sticky note in the sequence. Both arrows are active to indicate that there is a preceding sticky note in the sequence and a subsequent sticky note in the sequence. FIG. 10C shows the next sticky note in the sequence. The top arrow is active, indicating that there is at least one previous sticky note in the sequence. The bottom arrow is not active, indicating that there are no further sticky notes in the sequence.

In the context of teaching mathematics, the technique is configured to enable content of each sticky note (e.g., feedback page of a feedback set) is progressively more detailed to be progressively more helpful to the student or the teaching in teaching the topic at hand. As well, each type of error is addressed singly in a separate feedback page, rather than all feedback to all errors on one page. Presenting only one feedback at a time can be advantageous to a student who is trying to understand a concept by using error feedback. The student can correct one error at a time. In contrast, when all the feedback is presented at the same time, the student can become overwhelmed and confused.

FIG. 10D and FIG. 10E illustrate further examples of the specific feedback given to users of the opener and closer to allow the student to analyze and correct any errors.

In an embodiment, an opener is configured to improve learning and student engagement as follows. The opener system is intended to precede the guided lesson, which is to be completed independently by a student. The opener is intended to be led by a teacher and can take eight-ten minutes of instructional time. In this way, the opener can lead the teacher from less sophisticated problems to more sophisticated problems by the technique displaying less sophisticated models to more sophisticated models.

The opener system can be configured to:
Review and link previous learning to content in the guided lesson;
State the objective/purpose of overall lesson sequence;
Prepare the students for any important content in the guided lesson that requires front-loaded support;
Emphasize visual learning;
Address possible misconceptions;
Highlight new or special case uses of visual models; and
Gain attention and engage students in math content.

Types of Openers.

The system can configure the opener to be one of four types, described as follows.

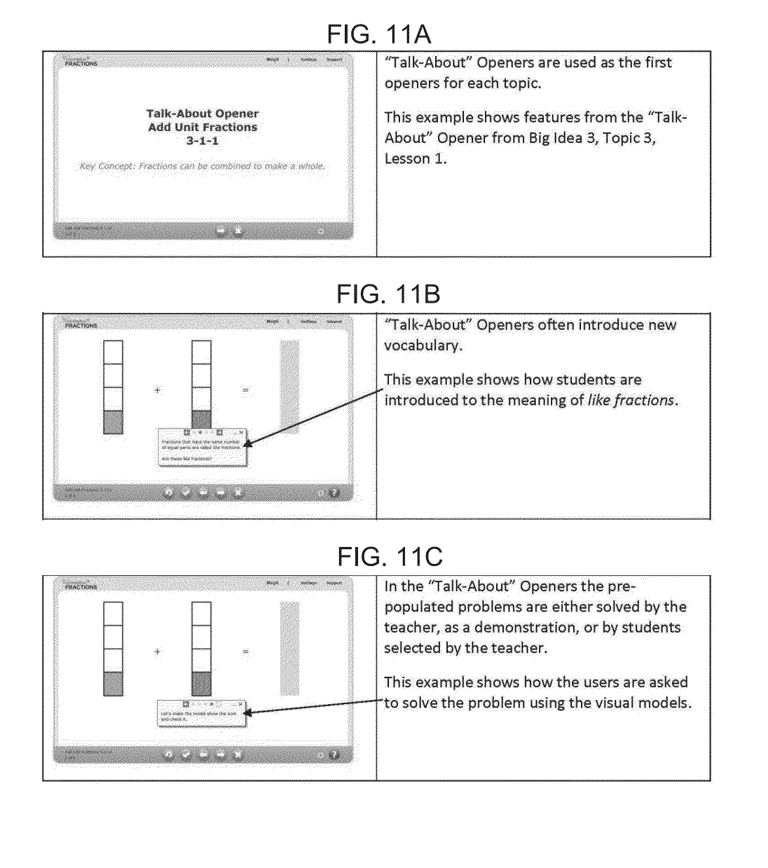

Talk-About. The talk-about-style opener is configured to guide a teacher in leading a whole class discussion designed to prepare students for the upcoming guided lesson (FIGS. 11A, 11B, and 11C).

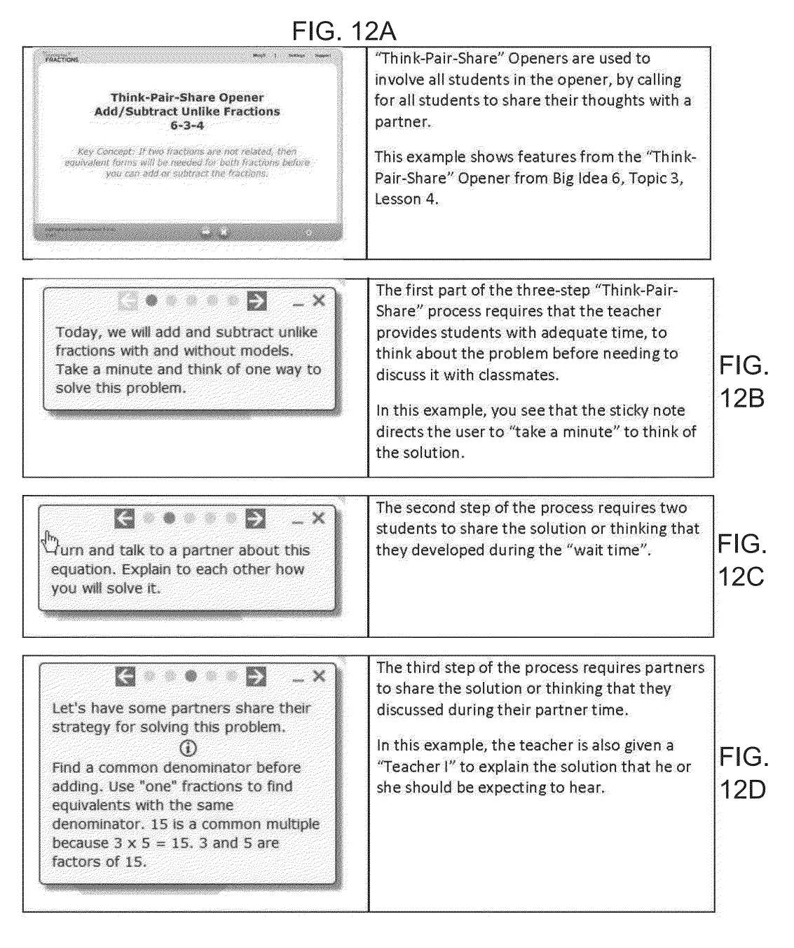

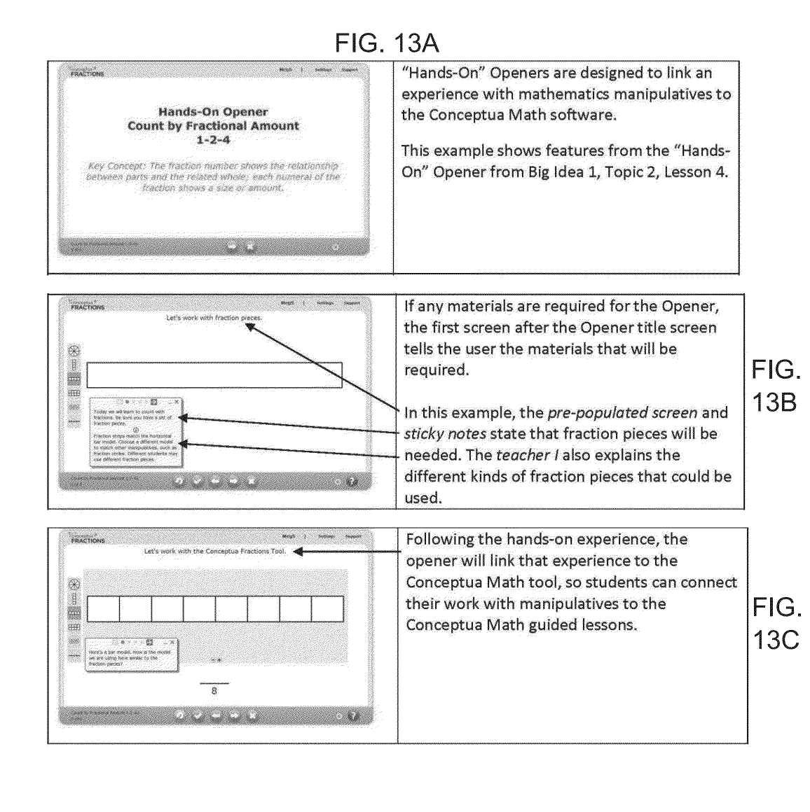

Think-Pair-Share. The think-pair-share style opener is configured to involve students in partner work. The opener is configured with a three-step sequence of sticky notes, to prompt teachers to allow independent thinking time, time to discuss with a partner and opportunities for students to share their thinking (FIGS. 12A, 12B, 12C, and 12D).

Hands-On. The hands-on-style opener is configured to guide teachers and students through the use of manipulatives to increase student engagement and prepare students to be able to successfully commence the guided lesson (FIGS. 13A, 13B, and 13C).

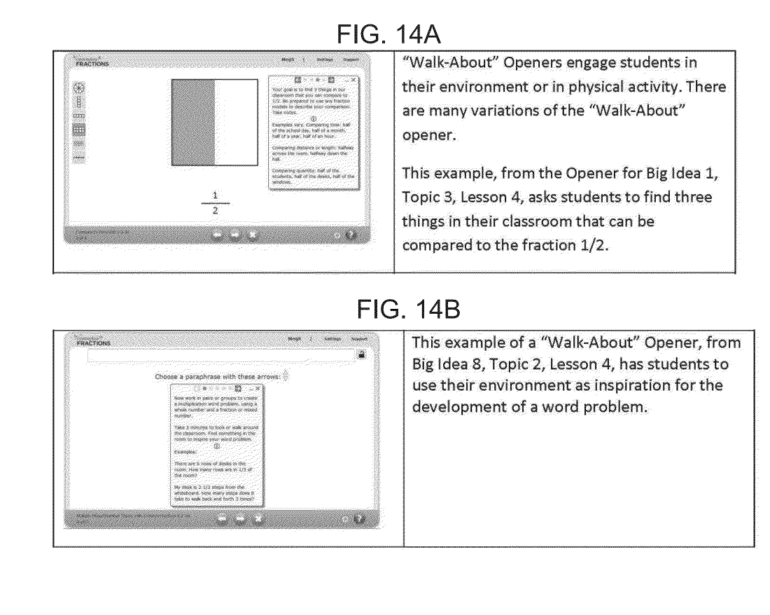

Walk-About. The walk-about-style opener is configured to engage the students in increasing understanding necessary to approach the guided lesson by having the student move within their environment or to see mathematics in the world around them (FIGS. 14A and 14B).

A Closer.

In an embodiment, a closer is configured to summarize and linking key concepts to advance understanding and to reinforce the lesson previously taught. A closer follows the guided lesson, which is completed independently by a student. The closer is configured to be led by a teacher and typically take five minutes of instructional time.

A closer is configured to:
Summarize the key learning objectives from the guided lesson;
Link previous learning to learning from the guided lesson and to prepare students for future learning; and
Check for understanding of key concepts.

Types of Closers.

The system can configure the closer to be one of three types, described as follows.

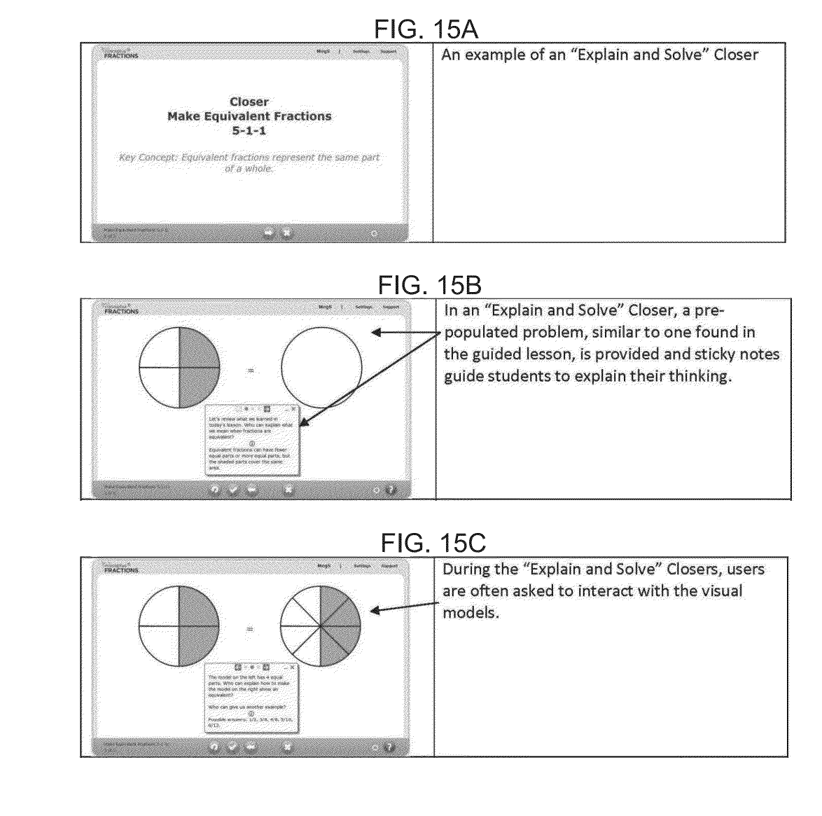

Explain and Solve. This explain and solve closer is configured to help the students review learning by solving a problem similar to one solved during the guided lesson. This problem is selected or authored to be used to support the summary of the key concept. This closer can be demonstrated by a teacher or student while engaged in whole class problem solving (FIGS. 15A, 15B, and 15C).

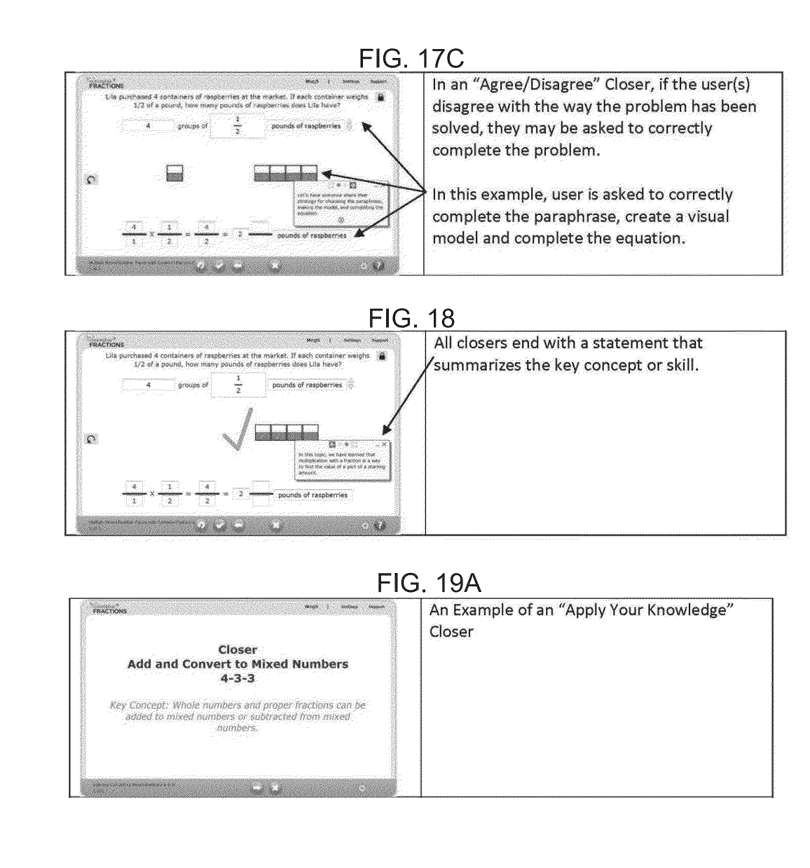

Agree/Disagree. This agree/disagree style closer is configured to present students with a problem, solution or strategy for evaluation. After being provided with a completed or partially completed solution or explanation, the students will be asked to assess it and explain whether they agree or disagree with what has been presented to them (FIGS. 17A, 17B, and 17C).

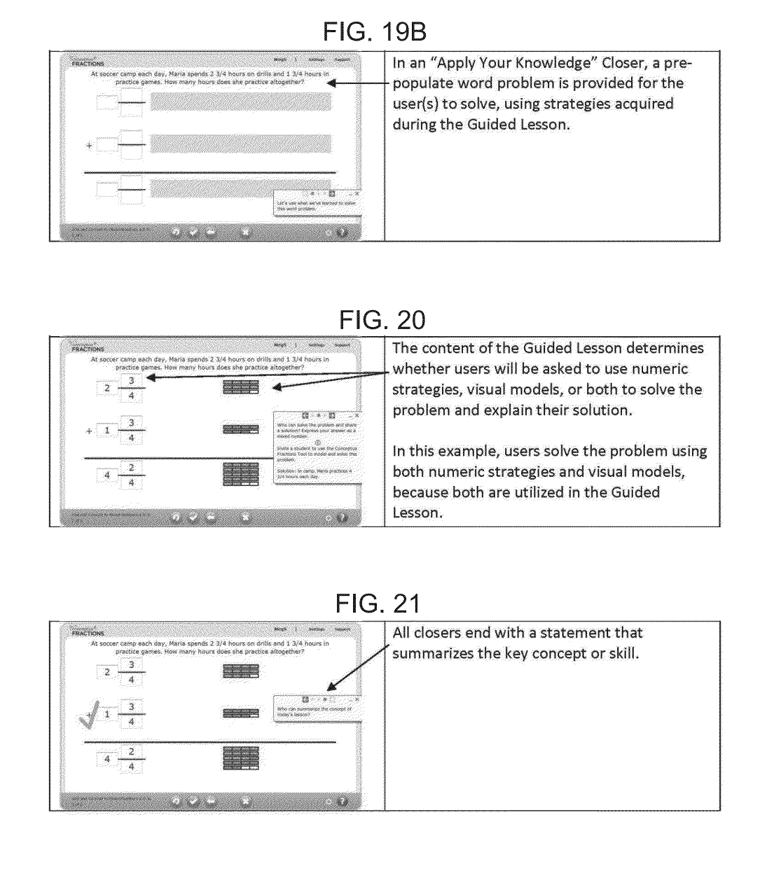

Apply Your Knowledge. This apply your knowledge closer style is configured to presents a student with a word problem to solve using the strategies they gained by working in the guided lesson (FIG. 19A, FIG. 19B, and FIG. 20).

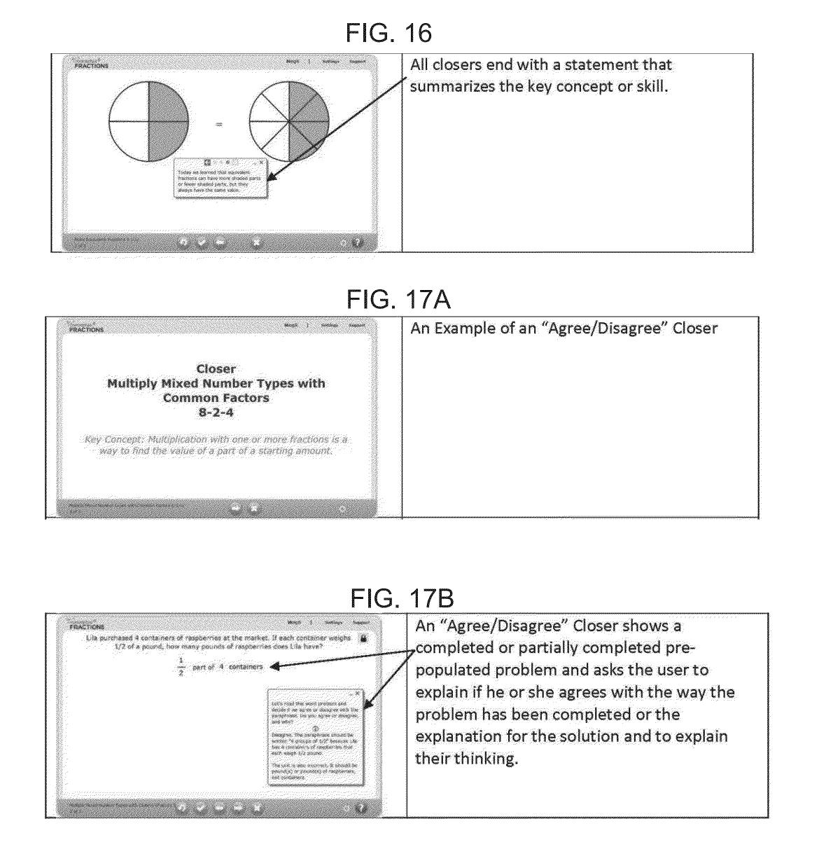

FIG. 16, FIG. 18, and FIG. 21 are each an example closer containing an ending sticky note that contains a statement that summarizes the key concept or skill,

Pre-Populated Problems.

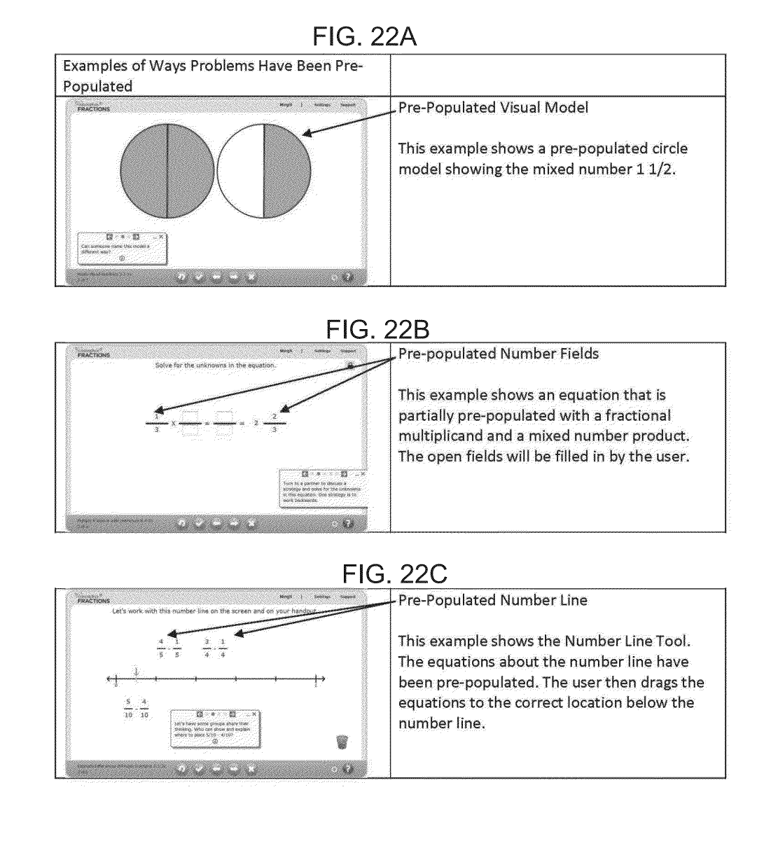

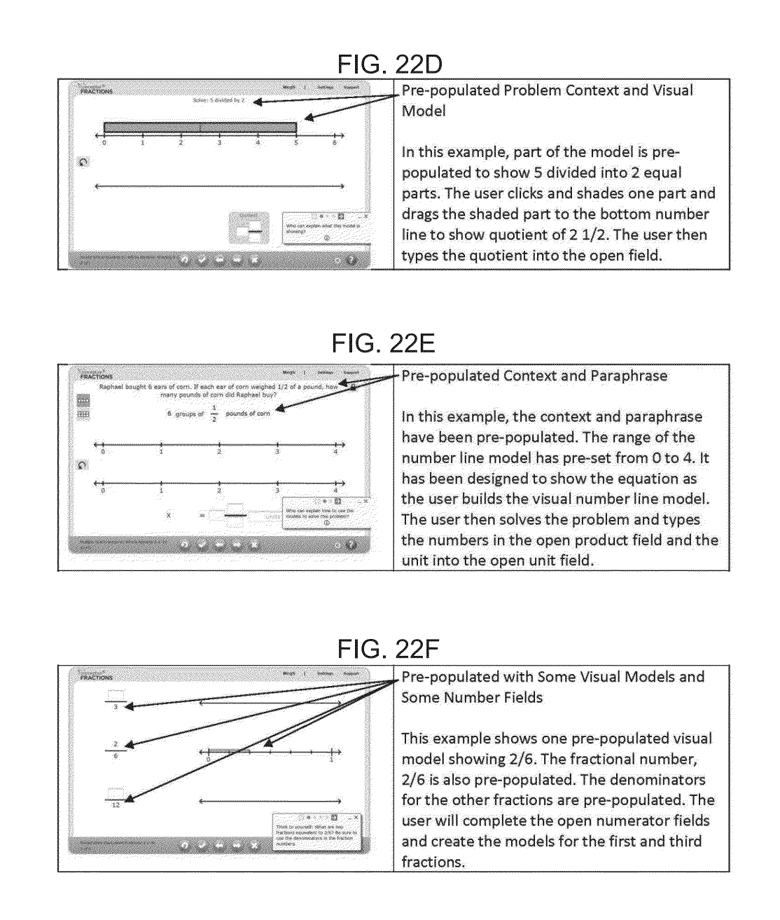

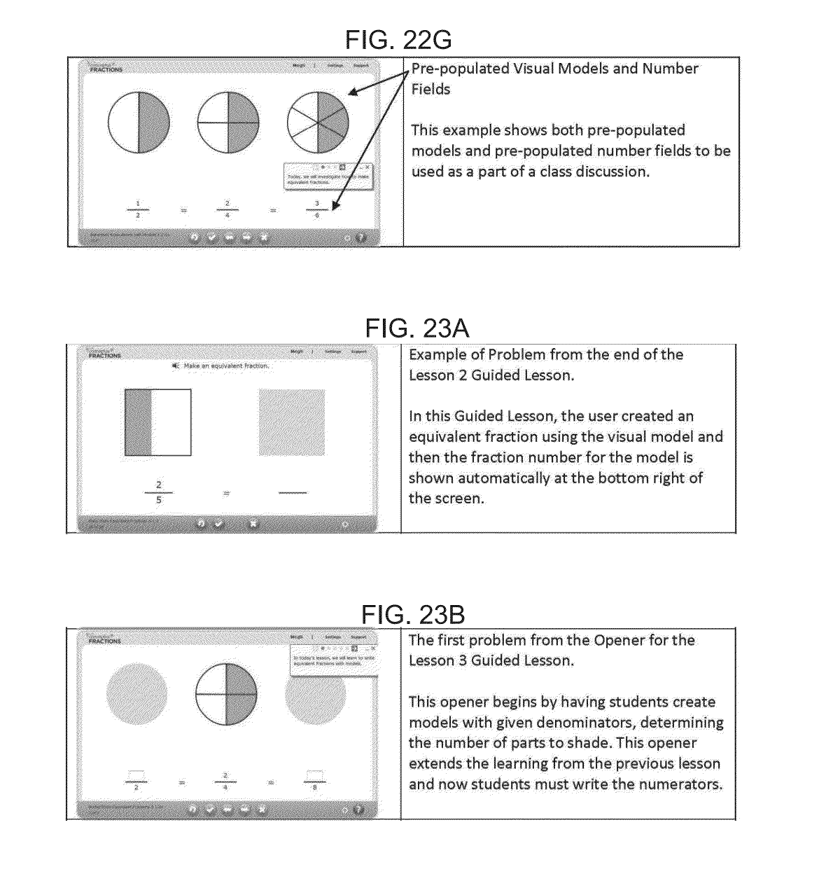

An important element of the opener and the closer is a pre-populated problem screen. This screen is configured to contain interactive, manipulative models. The opener and the closers are configured to set up the visual tools with content and settings to be used in the classroom. In the openers and closers, an author can set the initial values for a specific problem. The models palette and tools palette can typically be hidden, unless they are specifically needed to be utilized for completion of the opener. FIG. 22A-22G are examples of how the system is configured to pre-populated a problem.

The pre-populated problem in the opener is configured to enable the teacher to link the previous guided lesson with the forthcoming guided lesson.

The pre-populated problem in the closer is configured to enable the teacher to summarize the learning that was acquired during the guided lesson and to link previous learning experiences.

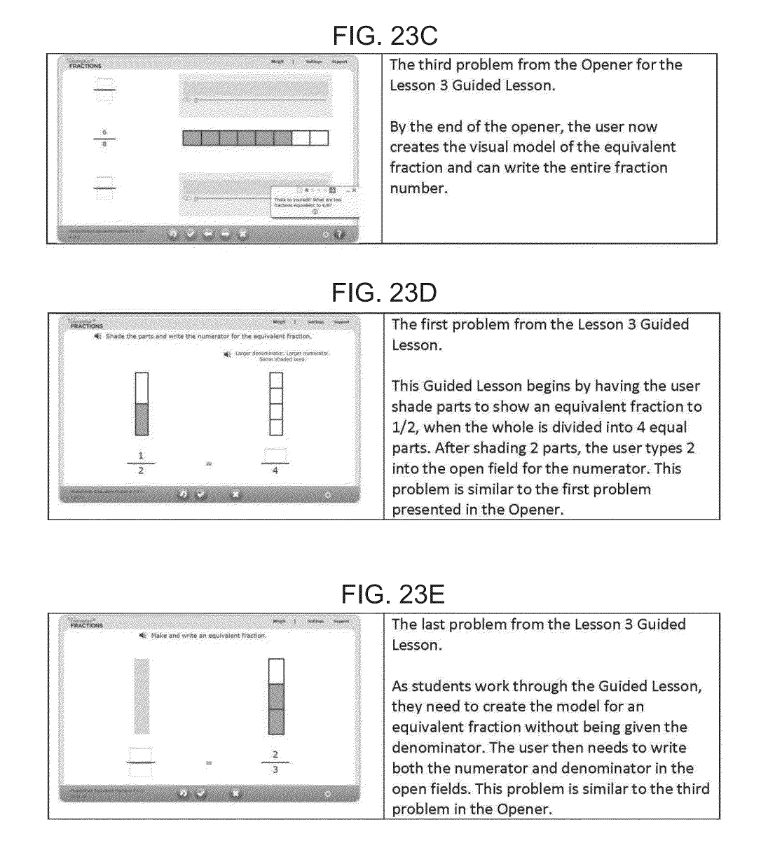

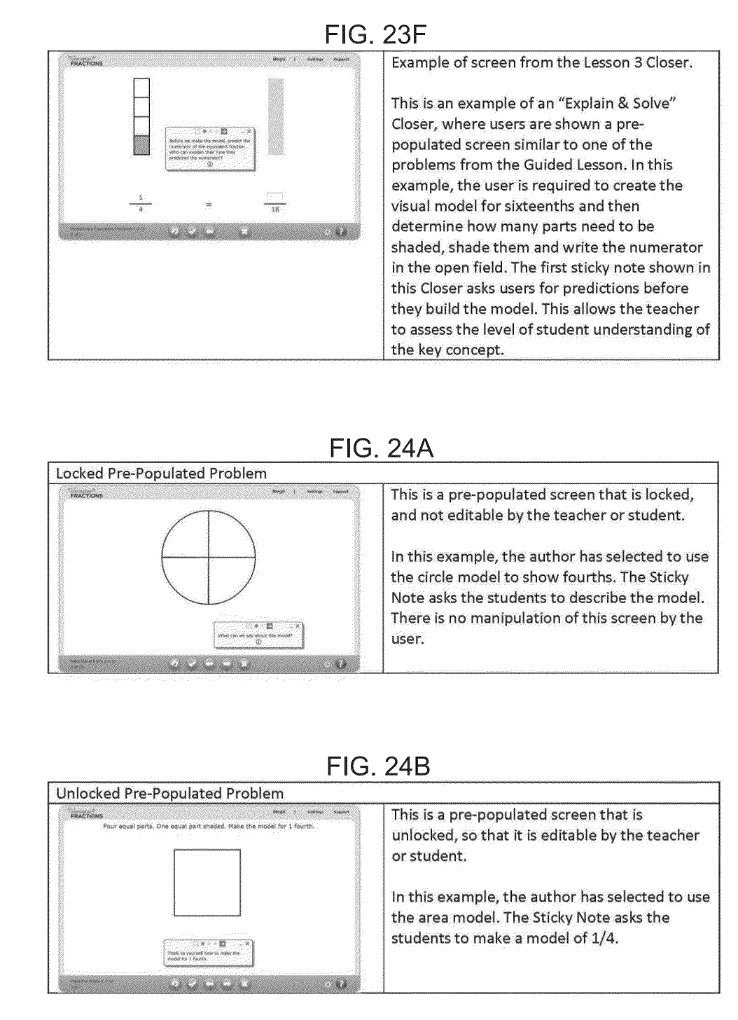

FIG. 23A-23F show an example of a flow from one guided lesson to the following opener, the current guided lesson, and the closer. This set of examples is sampled from a particular big idea 5 and topic 1, which addresses equivalent fractions,

Locked/Unlocked Pre-Populated Problem.

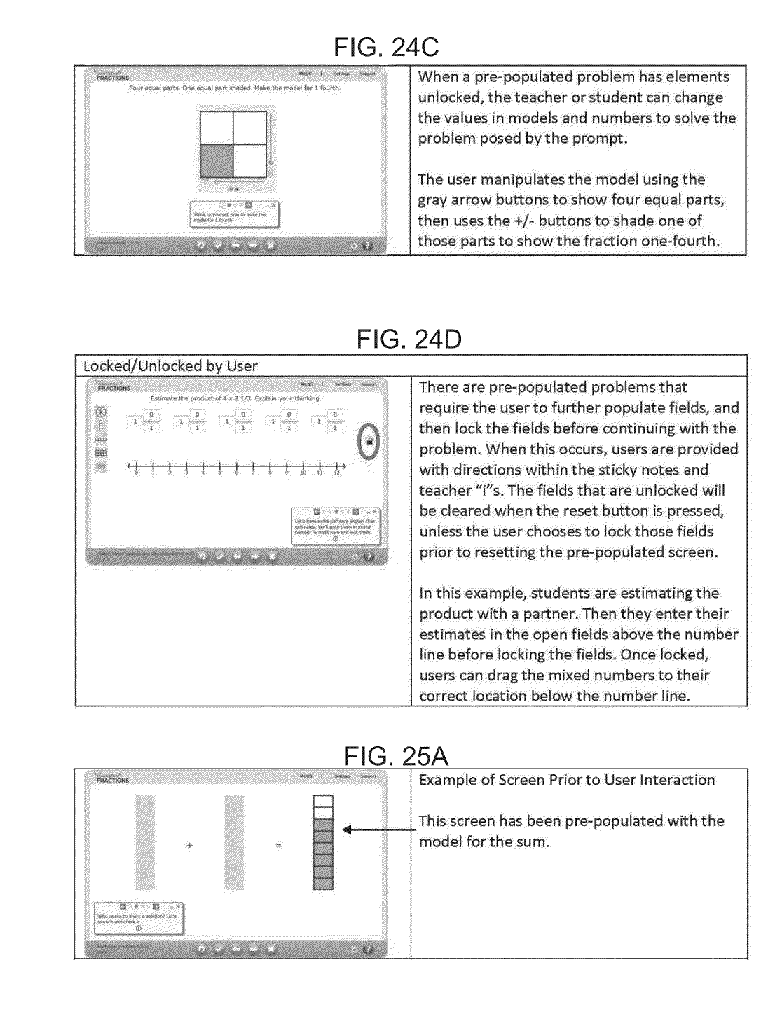

The system is configured to enable an author of the opener or closer to set the pre-populated elements of the screen and choose which elements are locked and which are not. The author can also choose to allow the user to lock and unlock the parts of the problem. FIG. 24A illustrates an example of a locked, pre-populated problem. FIGS. 24B and 24C each illustrate an unlocked, pre-populated problem. FIG. 24D illustrated an example of a pre-populated problem that requires the user to further populate fields and then lock the fields before continuing with the problem.

Resetting Pre-Populated Problem Screens.

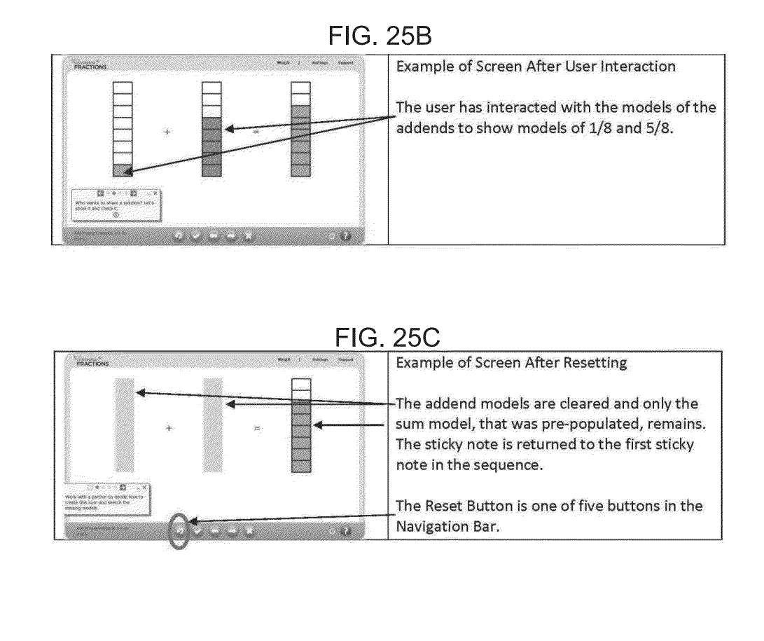

The system is configured such that after users have filled in part or all of the open fields, the user is enabled to press a reset button in a navigation toolbar. Pressing the reset button causes the system to clear open fields, while leaving the pre-populated elements of the screen. this allows users to experiment freely as they problem solve. Examples are illustrated in FIGS. 25A, 25B, and 25C.

Interstitial Screens.

The system is configured to include interstitial screens within an opener application or a closer application. An interstitial screen is a screen that can include text, images, audio and/or video to support learning. For instance, an interstitial screen can explain a concept to the intended audience, e.g. the classroom, but not contain interactive or manipulative models and graphical user interfaces. The interstitial model can explain a concept but not ask the student to perform any function on the screen.

### Sticky Notes and Teacher I'S

An opener and a closer contain a sticky note widget that can contain a teacher I icon, which when activated, can cause the sticky note to overlay additional area on the screen which contains additional content.

Sticky Notes.

A sticky note in an openers and closers is configured to elicit particular discussion to explain, justify and apply learning. The language is student-facing in the plural-first person. A sticky note can help the teacher emphasize student verbalization by using best-practices for questioning.

A sticky note can be configured to be initially displayed in one of nine locations:

Top Left;

Top Center;

Top Right;

Middle Left;

Center;

Middle Right;

Bottom Left;

Bottom Center; and

Bottom Right.

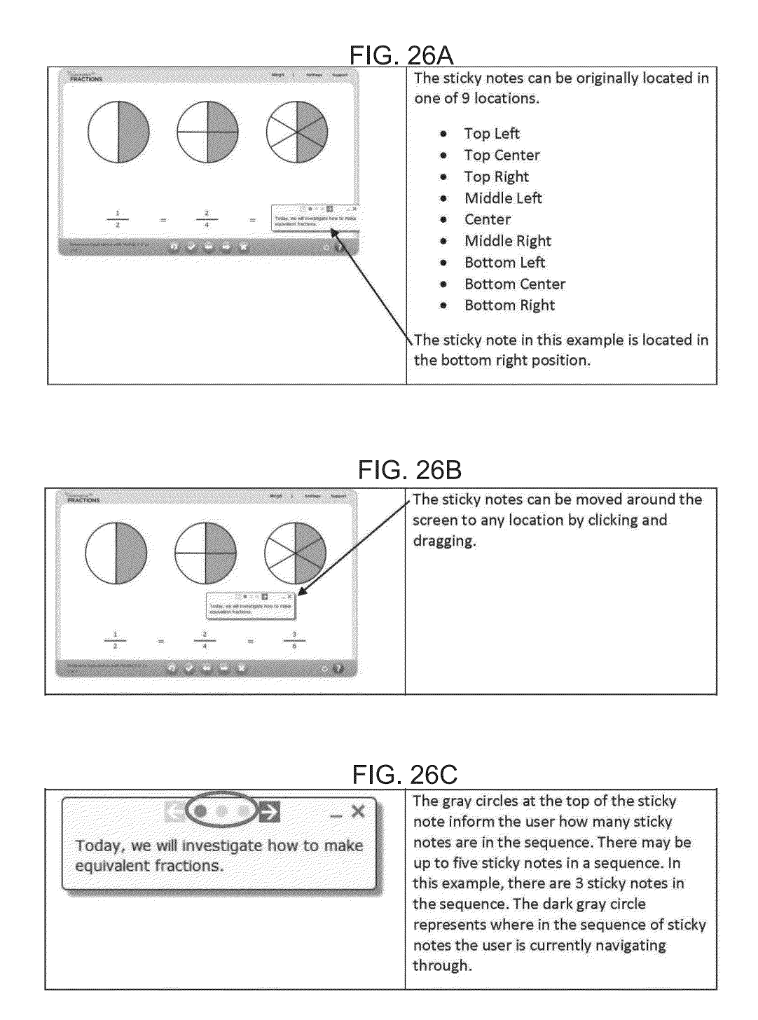

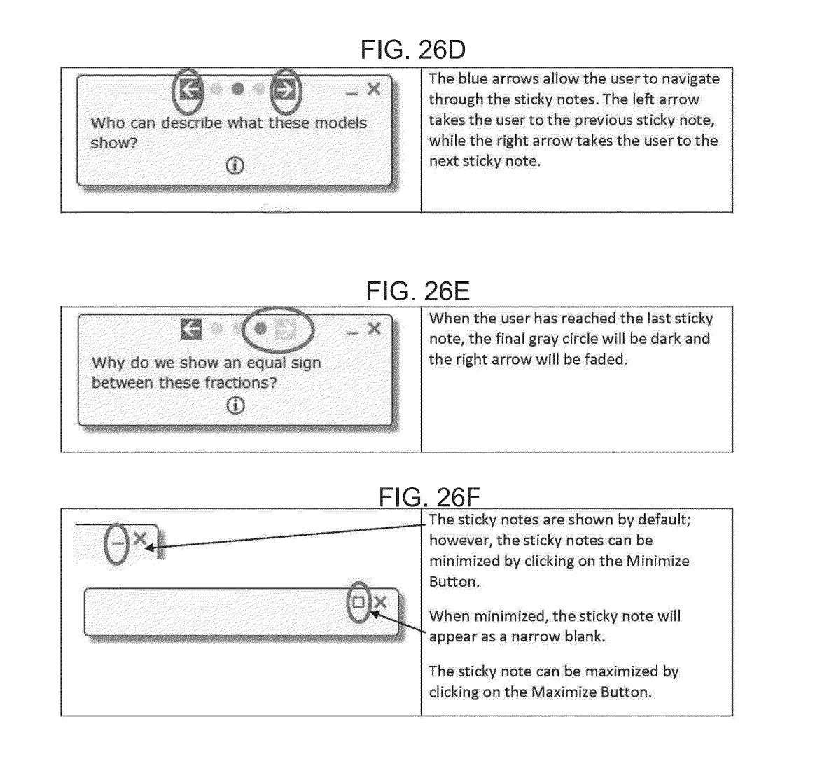

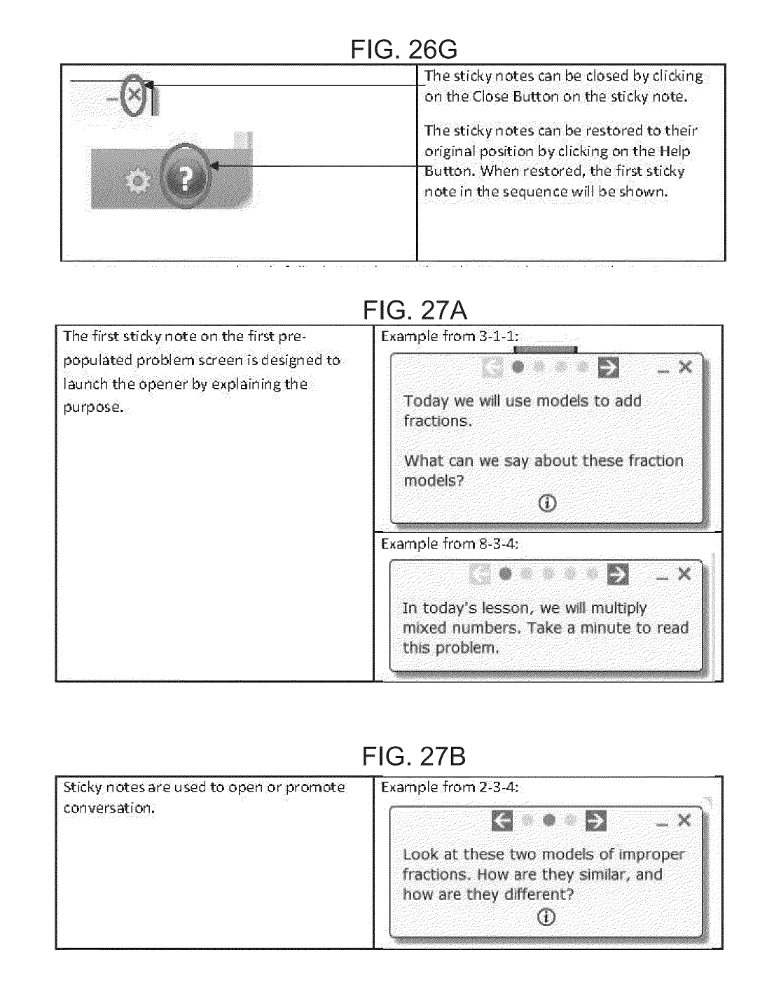

An example is illustrated in FIG. 26A. By configuring where to display the sticky note initially, the author can ensure that the initially displayed sticky note does not cover specific content on the underlying pre-populated screen.

The sticky note can be moved around the screen to any location by clicking and dragging, as illustrated in FIG. 26B. As well, the stick note can be closed such that only its title bar is shown and the main content is hidden.

A sticky note is configured to cause a colored circle, e.g. a gray circle, at the top of the sticky note to inform the user how many sticky notes are in the sequence. There may be up to five sticky notes in a sequence. In the example shown in FIG. 26C, there are three sticky notes in the sequence. The circle represents where in the sequence of sticky notes the user is currently navigating.

The sticky note is configured to cause one or more arrows to display each of which allows the user to navigate through the sticky notes, e.g. pages. The left arrow takes the user to the previous sticky note, while the right arrow takes the user to the next sticky note. An example is illustrated in FIG. 26D. When the user has reached the last sticky note, the final gray circle is dark and the right arrow is faded, as illustrated in FIG. 26E.

The system is configured to cause the sticky note to be shown by default; however, the sticky note can be minimized, e.g. by clicking on a minimize button, as depicted in FIG. 26F. When minimized, the sticky note can appear as a narrow blank. The sticky note can be maximized, e.g. by a user clicking on the maximize button.

The system is configured to cause the sticky note to close, e.g. by clicking on a close button on the sticky note, as depicted in FIG. 26G. The sticky note can be restored to its original position, e.g. by clicking on a help button. The system can be configured such that when the sticky note widget is restored, the first sticky note in the sequence is shown.

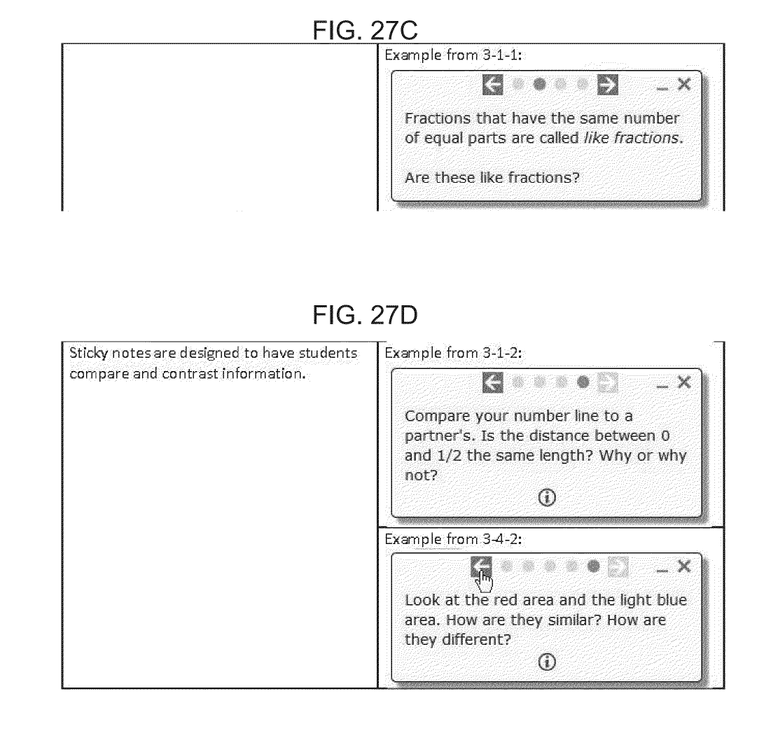

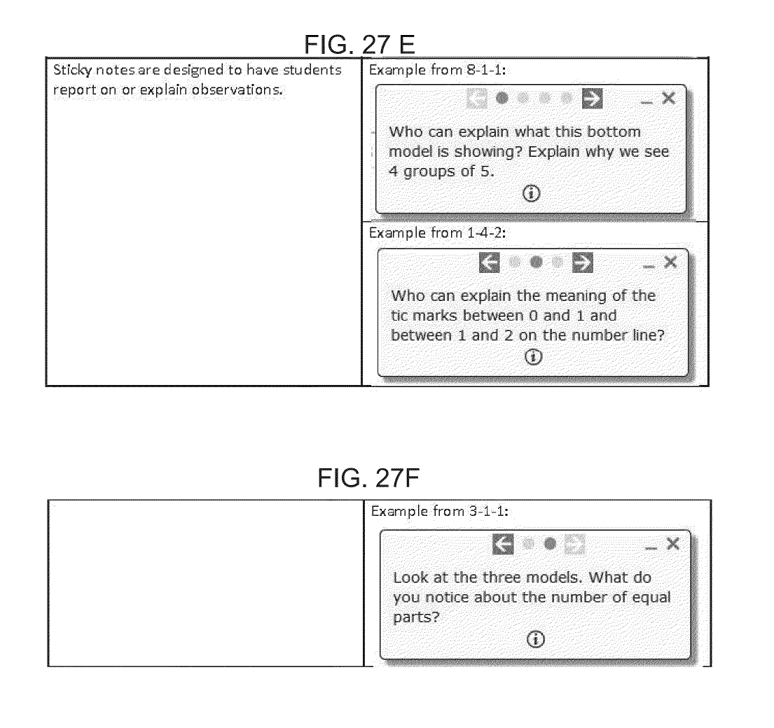

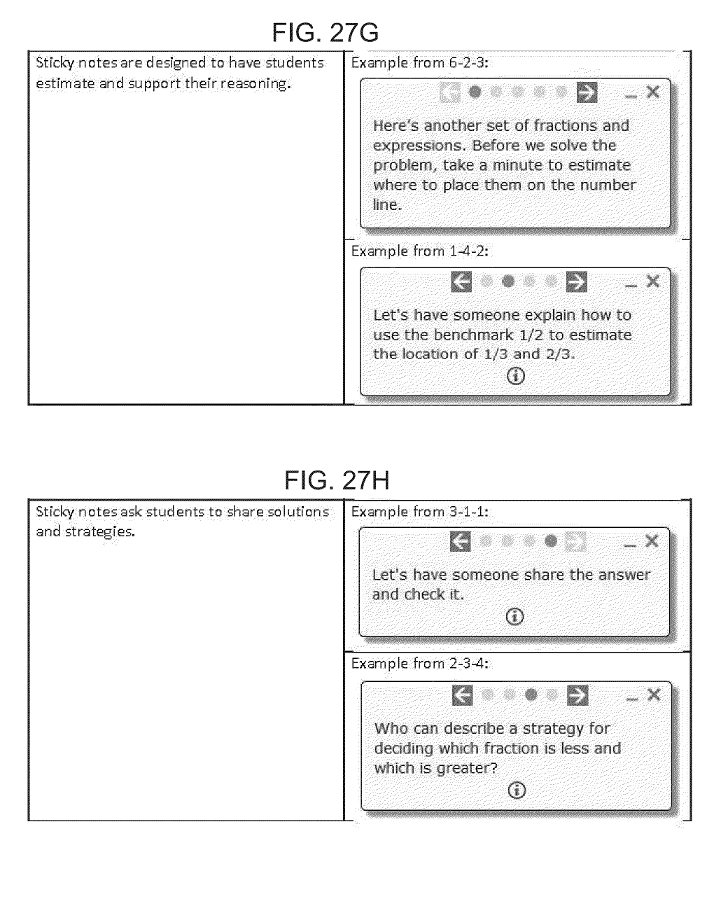

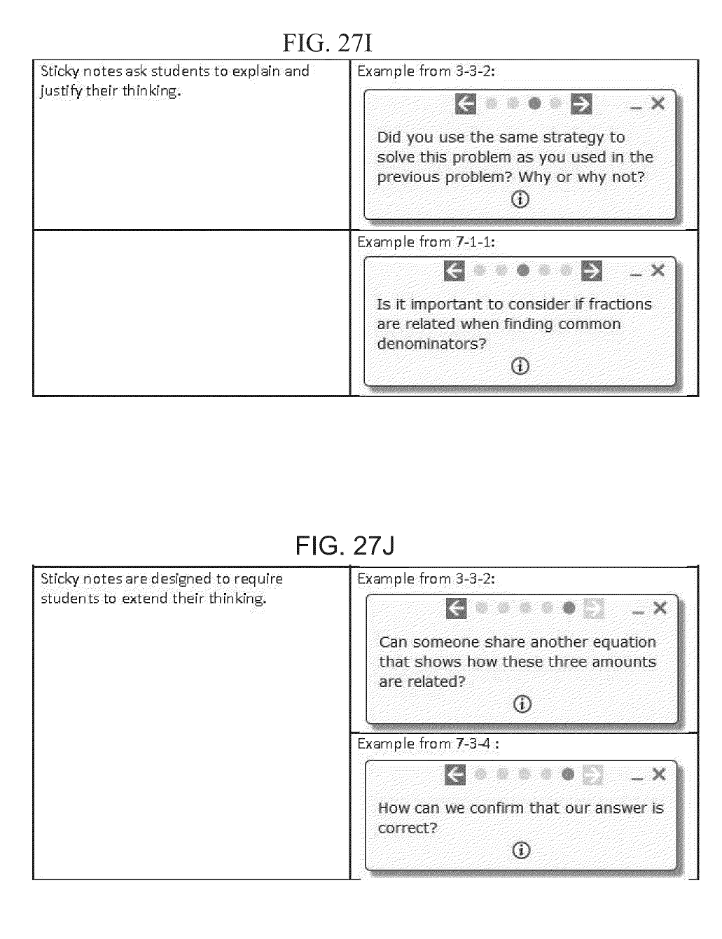

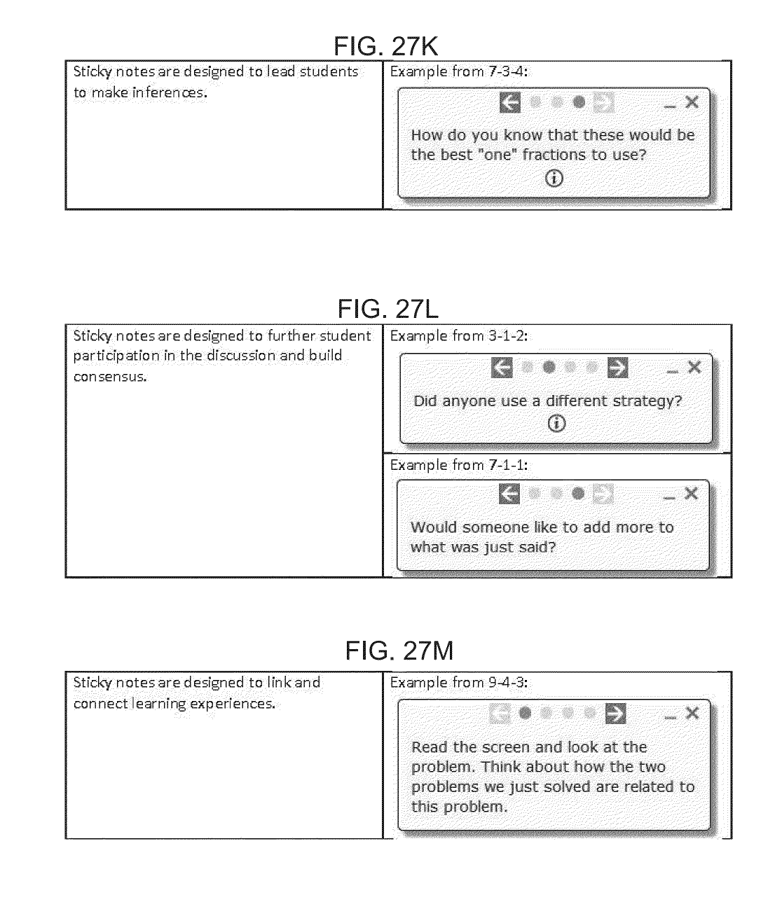

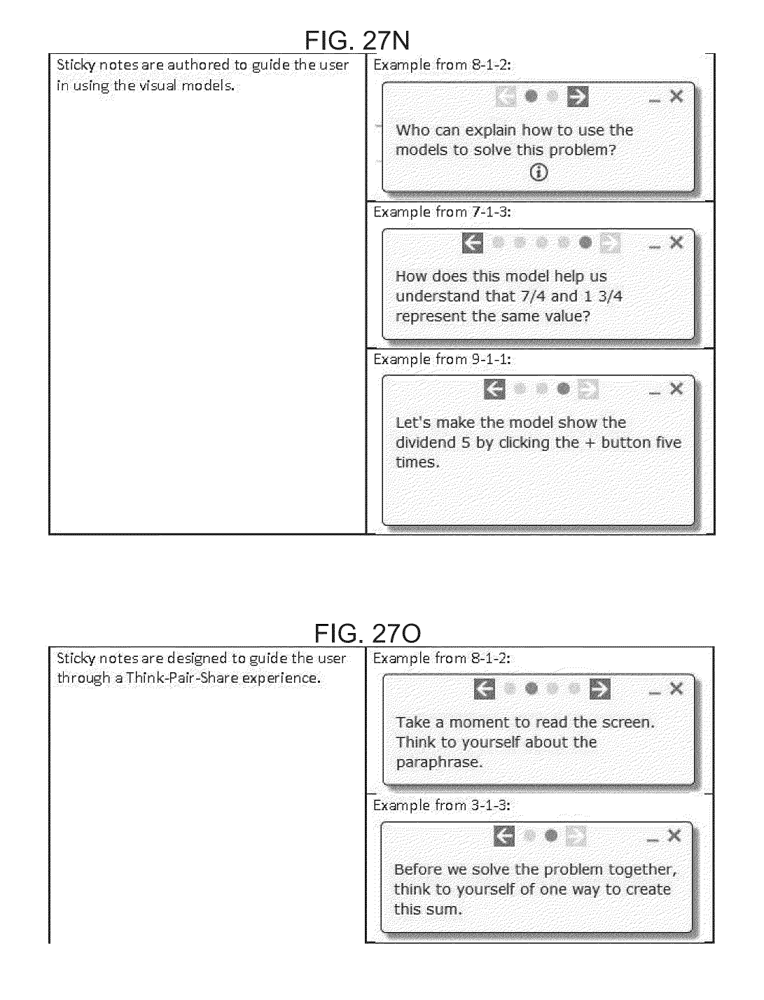

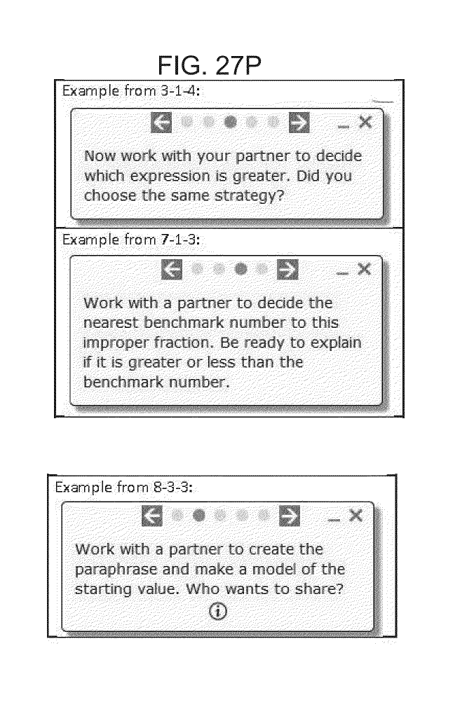

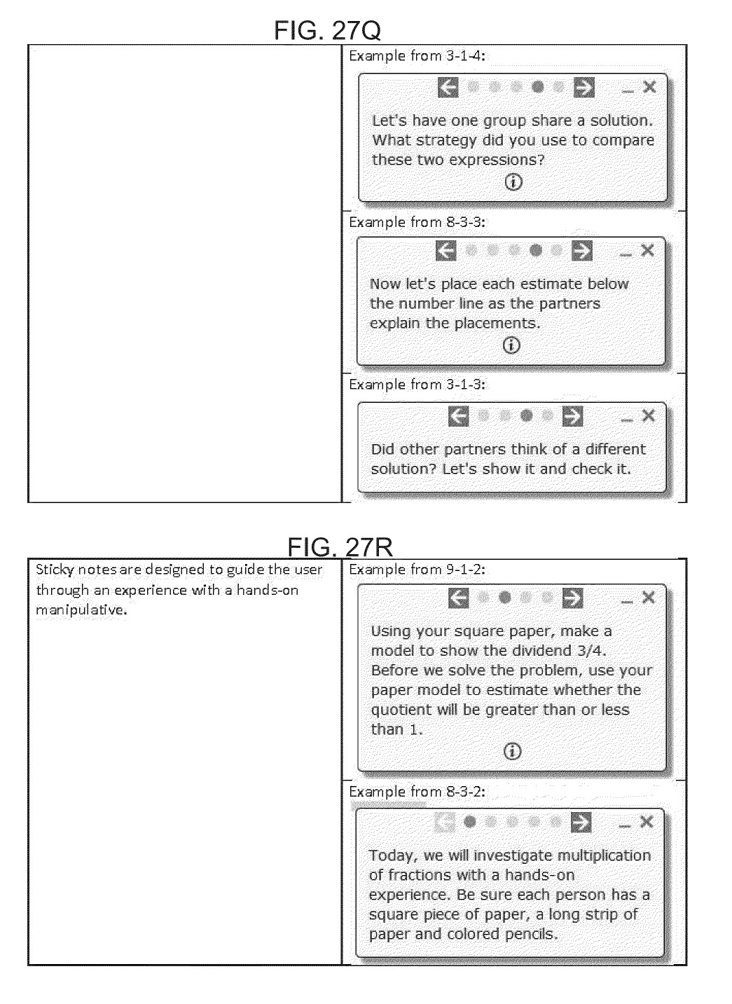

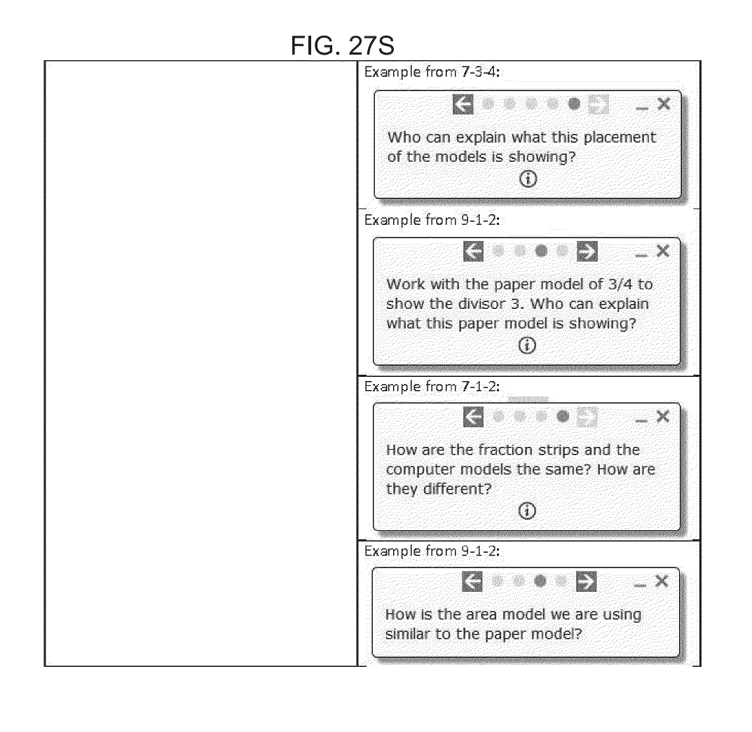

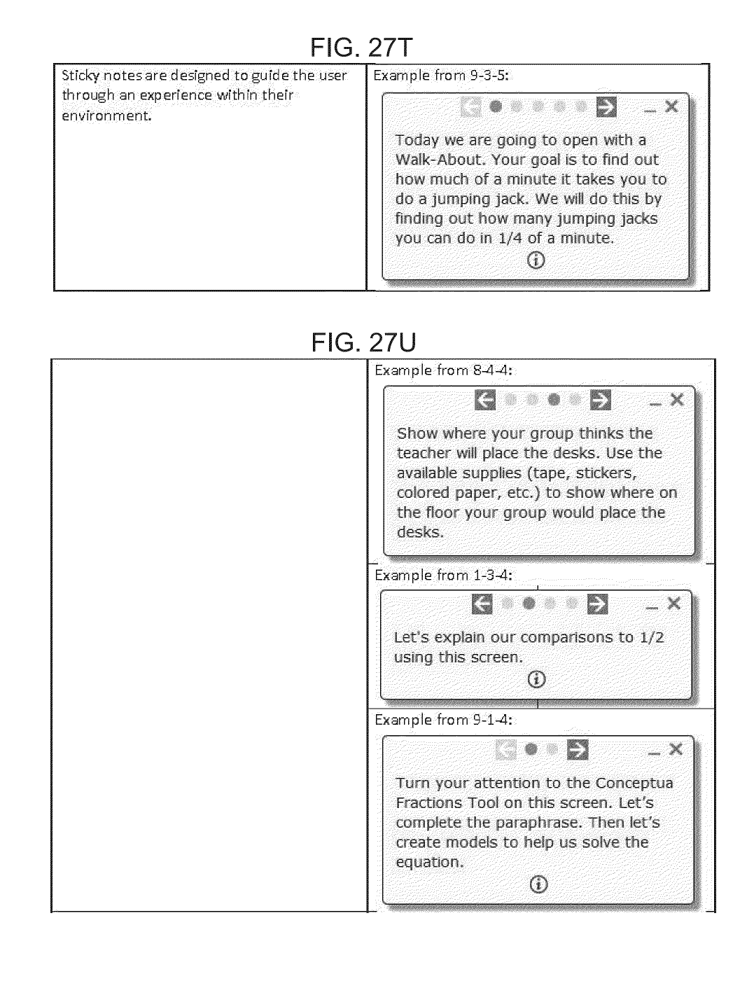

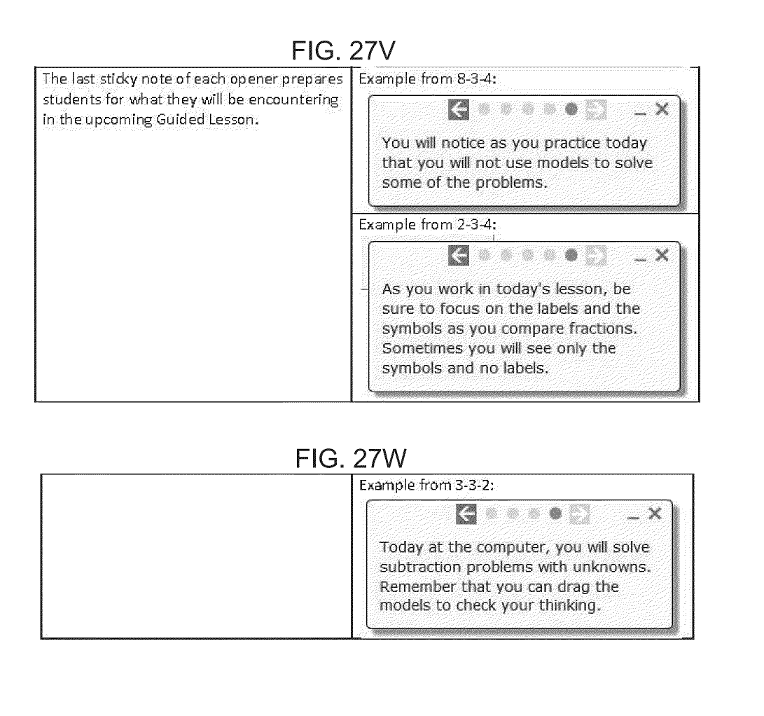

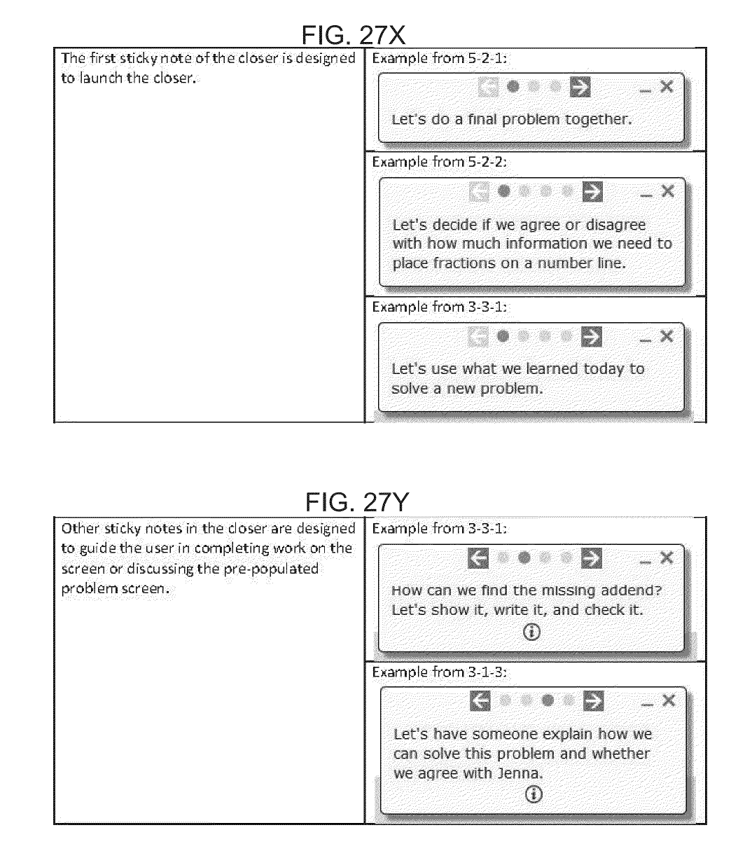

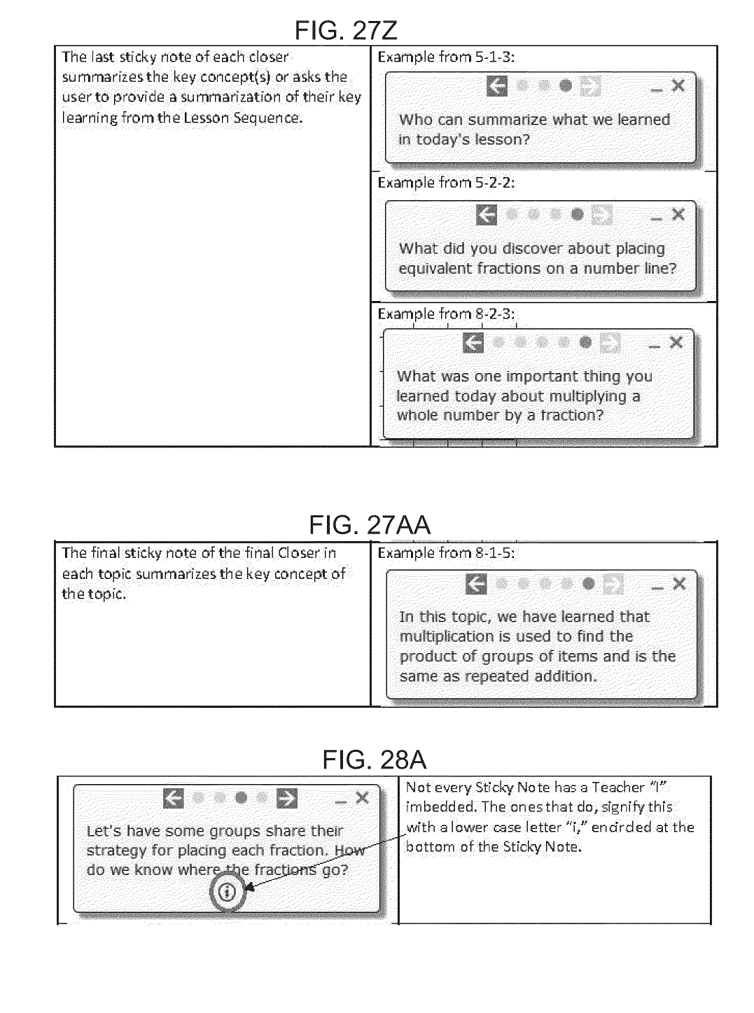

Discussion prompts are thoughtfully designed to guide a classroom lesson using best practices. FIG. 27A-27AA exhibit some of the many ways in which the system is configured to enable one or more sticky notes to guide the discussion during an opener and a closer. While this sampling of examples is extensive, by no means are the examples exhaustive.

Teacher “I”.

A sticky note is configured to contain a teacher “i”. A teacher i is an indicator, such as an icon, that, when activated, presents content, e.g. content knowledge. The teacher i is configured such that when activated, the system enables on-demand professional development for the classroom teacher. A teacher “i” can be viewed prior to teaching an opener or closer as part of the teacher's preparation for delivering a specific lesson sequence. In addition, a teacher i can be available to be viewed by the teacher and the classroom as the teacher delivers the instruction to his or her class, e.g. projecting the opener or closer on a white board. Further, a teacher i can be available to be viewed by the teacher in an application instance executed on a separate and independent device, e.g. a tablet within reach of the teacher, that can be referred to by the teacher as the teacher delivers the instruction to his or her class, e.g. by executing another instance of the application and projecting that instance on a white board. The language on the teacher “i” is teacher-facing, but is appropriate for students to see. The teacher “i” is usually in sentence form, but can pose a follow-up question. The tone and content of the teacher “i”s is respectful of the educator's pedagogical knowledge.

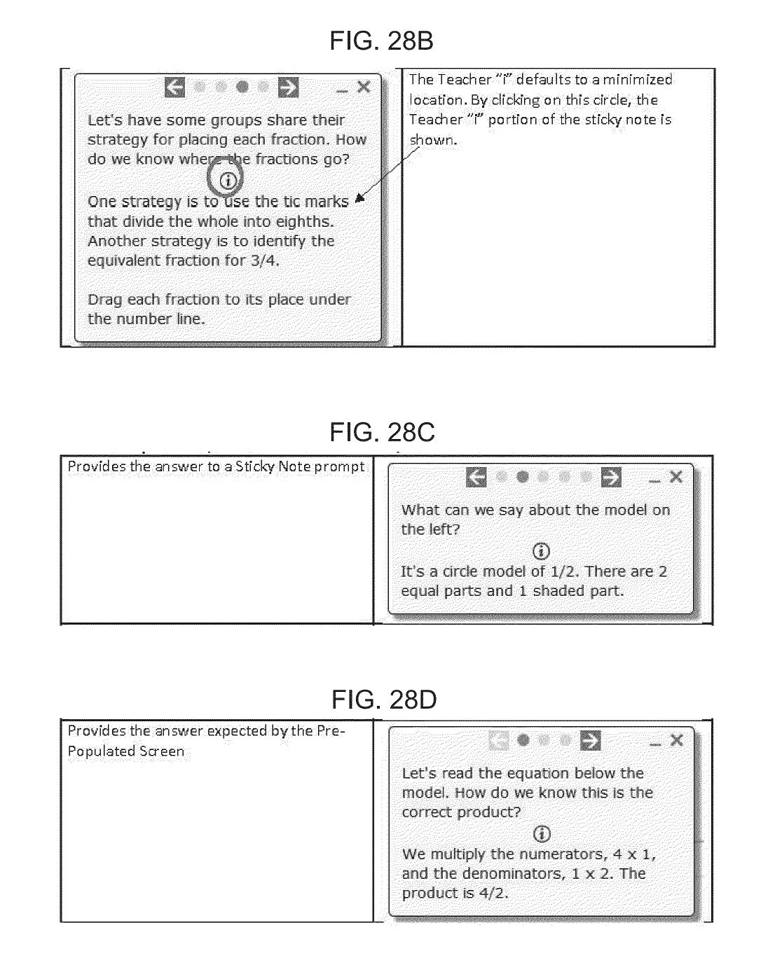

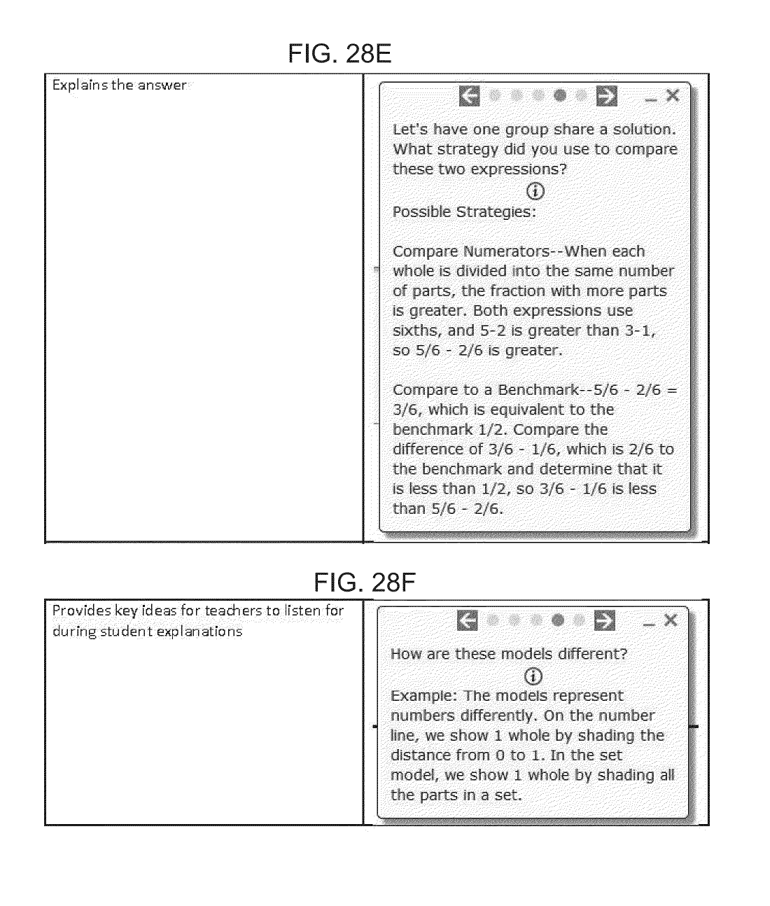

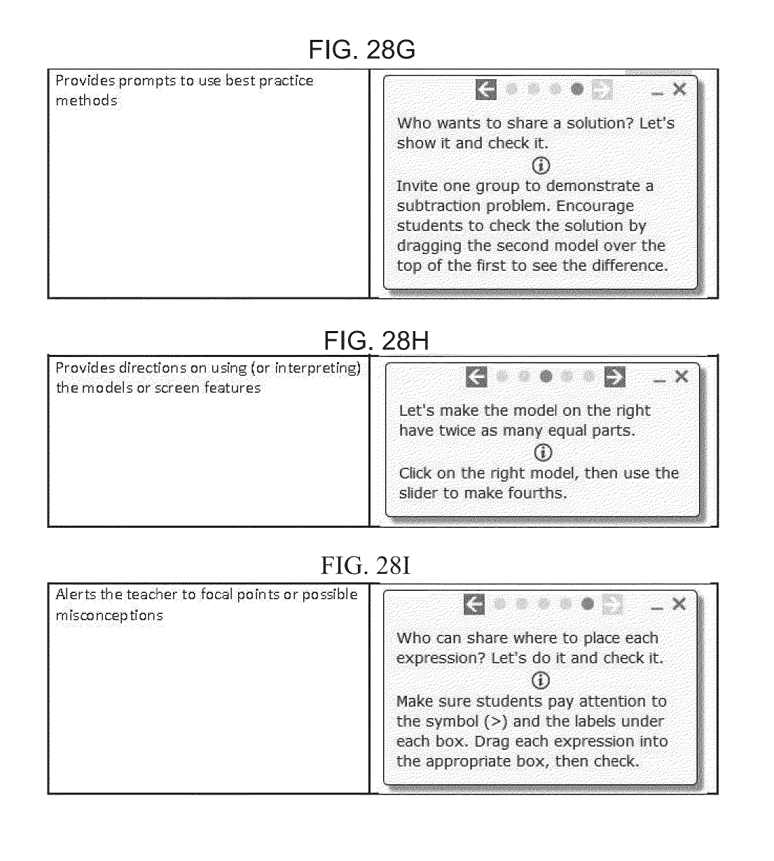

Not every sticky note is configured to have a teacher i embedded. In an embodiment, an embedded teacher i is depicted with a lower case letter i, encircled at the bottom of the sticky note, as depicted in FIG. 28A.

The teacher “i” can default to a minimized location. The teacher i is configured such that when the circle is clicked, the teacher i portion of the sticky note is shown by overlaying a portion of the screen that is positioned below the teacher i side of the sticky note. An example is illustrated in FIG. 28B.

A teacher i can be used for a variety of purposes. Some of those purposes and examples of how they are used, while not an exhaustive list, are included in FIG. 28C-28I.

### AN EXAMPLE

An example configured opener can be the type of opener is think-pair-share. The sticky notes are authored to be compatible with the think-pair-share pattern. Think-pair-share can be configured to first show a model, intended for the students to think about a given problem. In this example, the first page of the sticky note can be configured to indicate that the students should think about the pre-populated problem displayed. The second page of the sticky note can be configured to display that each student should make a pair with a person next to them to discuss the problem. The third page of the sticky note can be configured to display that now each pair of students should share with the class their solution to the problem. Further, as the teacher listens to the pairs of the students sharing their solution to the problem, the teacher can click on the teacher i to learn what concepts the students should be indicating an understanding of or the misconceptions that the students have and should discuss. For example, the teacher i can indicate a list of ways to solve the problem. Then, the teacher can ask, for instance, if any of the students solved the problem by a specific way.

Continuing with this example, once the teacher has progressed through all the sticky notes and teacher i's on the first page of the opener, the teacher can use one of the navigation indicators to proceed to the next screen. The process can repeat. The next screen is associated with a set of sticky notes. For instance, the next screen can contain a manipulative model reflecting the problem and the teacher can read the first sticky note displayed. As well, the teacher can open the teacher i on the first sticky note to obtain guiding information. After the teacher is satisfied with the guidance on the first sticky note on the second screen, the teacher can progress to the next sticky note and teacher i until the sticky notes and teacher i's for the second screen are exhausted. This process proceeds to a next screen and repeats until there are no more screens to the opener.

Similarly, the close can have multiple pages with each page being associated with a set of sticky notes and teacher I's.

### Discussion on Research-Based Authoring

An opener and a closer are unique in that they seamlessly tie together teacher-driven classroom instruction and computer-based learning and are specifically authored to link learning between each of the guided lessons. An opener and a closer can each be authored using tools to author the guided lessons, such that there is consistency within the lesson sequence.

An opener and a closer can each be configured to promote standards of mathematical practice, e.g. the Standards of Mathematical Practice as published for the schools in the United States.

In addition to promoting the standards, the openers and closers can be authored using research-based pedagogical strategies. Authors can make decisions as to which visual models to use, how to populate the problem, and which questions to ask and information to provide through the configured sticky notes and teacher i's, in an effort to prepare students for the next guided lesson in the sequence.

Dr. Madeline Hunter's ITIP Mode tells us that when effective teachers design lessons, they purposely plan to activate prior knowledge, explain learning objectives, provide students with information they need to acquire new knowledge and check for understanding. These practices or any others can be bunt into an opener. Dr. Hunter's work also includes the importance of guided practice and lesson closure, other important elements of a lesson sequence.

In Classroom Instruction that Works: Research-based Strategies for Increasing Student Achievement, Dr. Robert Marzano and his team set out nine research-based instructional strategies that have measureable effects on student learning. These strategies can be incorporated into a lesson sequence. For example, the technique enables resetting the pre-populated screens in the configured opener and in the configured closer, which allows students to generate and test multiple hypotheses, as recommended by this research. A closer can be configured to focus strongly on summarizing, another important strategy for increasing student achievement. Marzano's work also stresses the importance of asking questions that focuses students' thinking on key information. Pre-programmed and configured sticky notes and teacher i's encourage rich mathematical conversations, focusing on key learning objectives, during the opener and the closer.

In addition to focusing on important concepts, a pre-programmed sticky note and teacher “i”s can be configured to include strategies for productive discourse, as recommended by Suzanne Chapin, Catherine O'Connor and Nancy Canavan Anderson in Classroom Discussion: Using Math Talk to Help Students Learn. Incorporating these strategies into the sticky note and the teacher i enables a teacher to engage their students in math talks that result in increased learning and engagement. These discussions provide a common ground, in which all students can cement the learning they acquire during the independent guided lessons.

### Technology Framework for an Interactive Opener and Closer

Below is an outline of system requirements to configure an opener and a closer.

Openers
Type of opener
Openers are categorized by structure. Structures are chosen from best practice and research. The opener can be configured to use a select set of structures to enable the teacher to generalize these structures to other content.
   Talk About
   Think, Pair, Share
   Hands On
   Walk About
Key Concept
The key concept can be configured to make the learning objective explicit to teachers and students.

Closers
Type of Closer—The closer can be configured to use the following select set of structures to enable the teacher to summarize the lesson.
   Explain and solve
   Agree/Disagree
   Apply Your Knowledge
Key Concept
   This is repeated from the corresponding opener.

Openers/Closers Structure—The opener and the closer can each be configured as follows:
To have a title screen with type and key concept.
To have any number of interstitial screens with supporting text and any of
   images
   audio
   video
To have navigation means, including:
Enabling the teacher to move back and forth between screens, allowing for a fluid environment that lets the teacher go back to prior discussions points when necessary.
To have one or more multiple discussion screens to allow an author to create scaffolded interactions that build student understanding across one or more interactions and carefully chosen examples.
Each discussion screen has
   A prompt, optionally and commonly pre-populated.
      Can be unlocked (editable by teacher or student)
      Can be pre populated with text, symbols and numbers,
      Can be locked (not editable by teacher or student).
      Can be lockable/unlockable at discretion of user or lock state can be preset,
   Interactive, checkable models and numbers
      Can be optionally and commonly pre populated
      Interactive Models and numbers
         Teacher or student can change values in models and numbers to solve the problem posed by the prompt.
         Default initial state can be empty.
         Author can set initial values for a specific problem.
         Models and numbers can be reset by the user to an initial state at any time such that the teacher and the students can experiment freely, using a reset button.
      Checking with strategic feedback for errors.
         The feedback does not directly provide answers.
         The feedback indicates which elements or fields of the model and numbers should be addressed and why these elements have been pointed out.
         There may be one or more sets of feedback for a single answer; each error is addressed with a separate set of feedback. The user can page through the feedback and address each error separately, or look at all errors first, then address the errors.
         Feedback helps both student and teachers move forward in discussion (if teacher is not dear, they can check work and the strategic feedback helps them move forward).
   Multi-page, Structured Discussion Prompts
      The discussion prompts leads the teacher and class through an examination and discussion of the problem presented by the prompt, models and numbers on the discussion screen.
      In one embodiment, the discussion prompt is a floating sticky note, but other embodiments contain the discussion prompt using a static panel, sliding panel, or other user-interface elements.
      Each page has
         Hidden teacher information that provides the teacher with teacher-specific support;
            questions to assess student understanding;
            ways to identify potential misconceptions;
            actions to take based on class responses to a posed question;
            directions for students to use the interactive models,
            other essential information
            It is important to note that this content can be both specific to the immediate problem and the stage of examination/solution and can be based on research and best practice, as content represents contextual, just-in-time professional development
         A button to hide/show the teacher information e.g., referred to as the teacher i).
      Page indicator (can be numeric or visual)
      Next and Previous buttons to change pages.
      The discussion prompts can be hidden or shown.
         Default is initially shown
         Authors can construct one or more discussion prompts that are initially shown.
         Users can manually hide the discussion prompts with a dose button and show them again with a help button.

Some Value
Teachers know that mathematical conversations (“math talks”) with students are a best practice and want to lead successful math discussions with their class.
   Some teachers may not be confident. The multi-page discussion prompts and the strategic feedback caused by interaction with the interactive and manipulative models and numbers give these teachers confidence.
   Some teachers can enhance their math talks with the interactive technology provided by the technique.
The technique provides scripted openers and closers that can save time and improve quality
   Content is research based and tested.
   The interactive models yield accurate mathematical representations, as opposed to hand-drawn models that are inaccurate and can lead to student misconceptions.
   The interactive models are efficient to create and modify as opposed to hand-drawn diagrams, which can take a longer time to draw; which inhibits experimentation on the part of both the teacher and the students.
Opener and closers and the embedded supports within them (e,g., a sticky note and a teacher i) act as timely professional development. Teachers can learn to deliver math talks on a challenging topic while teaching the topic by using this supported environment.
Students want to be engaged and to interact and participate, rather than just listen and practice,
   Students who participate in a mathematical discussion are able to talk out loud, to use interactive technology and to actively interact with their classmates.
   The interactive technology is engaging and makes mathematical concepts dear.
   Students can go to the front of the room and use the technology, e.g. using an interactive whiteboard, document camera or other projection device.
   Ability to reset the problem gives students the freedom to experiment with their solution.

### Another Embodiment

While the discussion above is from the point of view of the user being a teacher, the technique can be configured to enable the user to be a student. Each of the opener and the closer, each of which contain a sequence of screens having pre-populated problems and each screen having an associated sequence of sticky notes with teacher i's, can be configured to guide a student through a lesson. The prompts in the sticky note and the content of the teacher i's can be configured to address a student or group of students, rather than a teacher.

### An Example Machine Overview

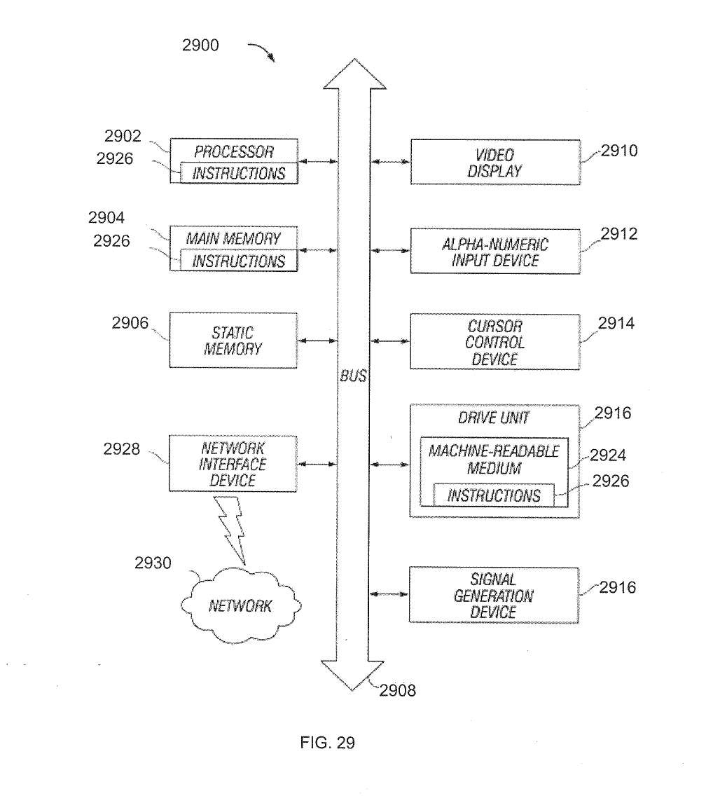

FIG. 29 is a block schematic diagram of a system in the exemplary form of a computer system 2800 within which a set of instructions for causing the system to perform any one of the foregoing methodologies may be executed. In alternative embodiments, the system may comprise a network router, a network switch, a network bridge, personal digital assistant (PDA), a cellular telephone, a Web appliance or any system capable of executing a sequence of instructions that specify actions to be taken by that system.

The computer system 2900 includes a processor 2902, a main memory 2904 and a static memory 2906, which communicate with each other via a bus 2908. The computer system 2900 may further include a display unit 2910, for example, a liquid crystal display (LCD) or a cathode ray tube (CRT). The computer system 2900 also includes an alphanumeric input device 2912, for example, a keyboard; a cursor control device 2914, for example, a mouse; a disk drive unit 2916, a signal generation device 2918, for example, a speaker, and a network interface device 2928.

The disk drive unit 2916 includes a machine-readable medium 2924 on which is stored a set of executable instructions, i.e. software, 2926 embodying any one, or all, of the methodologies described herein below. The software 2926 is also shown to reside, completely or at least partially, within the main memory 2904 and/or within the processor 2902. The software 2926 may further be transmitted or received over a network 2930 by means of a network interface device 2928.

In contrast to the system 2900 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complementary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a system or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

Further, it is to be understood that embodiments may include performing operations and using storage with cloud computing. For the purposes of discussion herein, cloud computing may mean executing algorithms on any network that is accessible by internet-enabled or network-enabled devices, servers, or clients and that do not require complex hardware configurations, e.g. requiring cables and complex software configurations, e.g. requiring a consultant to install. For example, embodiments may provide one or more cloud computing solutions that enable users, e.g. a teacher using a digital tablet, to lead a classroom discussion in mathematics on such internet-enabled or other network-enabled devices, servers, or clients. It further should be appreciated that one or more cloud computing embodiments include enabling a teacher to lead a classroom discussion in mathematics using a mobile device, tablet, and the like, as such devices are becoming standard consumer devices.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. An apparatus for providing a mathematical instructional tool, comprising:
one or more processors;
a storage in communication with said one or more processors; and
a display in communication with said one or more processors and with said storage, said display configured for displaying a graphical user interface (GUI) as part of the mathematical instructional tool, said GUI comprising:
a title screen configured to display a type of opener and a key concept;
one or more pre-populated content problem screens in a sequence, each screen configured to display a pre-populated visual model and one or more pre-populated number fields,
a sticky note widget configured to contain a sequence of one or more notes and to display one note at a time, wherein each note contains a prompt to guide classroom discussion;
a teacher i indicator embedded in the sticky note widget, wherein when the teacher i indicator is configured such that when activated, the activation causes a teacher instruction or suggestion to overlay a portion of the currently displayed pre-populated content problem screen;
a plurality of navigation indicators each of which when activated cause the current pre-populated content problem screen to reset, check work, go to previous screen in the sequence, go to next screen in the sequence, and dose, respectively; and
a feedback widget configured to contain a sequence of one or more feedback comments and to display one feedback comment in the widget at a time on the current pre-populated content problem screen in response to receiving input from an editable field on the current pre-populated content problem screen.
